(19) United States
(12) Patent Application Publication
(10) Pub. No.: US 2010/0137156 A1
(43) Pub. Date: Jun. 3, 2010

(54) CONSTRUCTION AND USE OF A FUNCTIONALLY HUMAN ANTIBODY LIBRARY WITH MAXIMIZED REPERTOIRE DIVERSITY

(76) Inventors: Shui-on Leung, Hong Kong (CN); Pui Fan Wong, Hong Kong (CN); Chi Wai Kwong, Hong Kong (CN); Yip Sum Chan, Hong Kong (CN)

Correspondence Address: SMITH PATENT CONSULTING, LLC, 3307 DUKE STREET, ALEXANDRIA, VA, 22314, US

(21) Appl. No.: 12/530,483

(22) PCT Filed: Mar. 10, 2008
(86) PCT No.: PCT/US08/56421

§ 371 Date: Jan. 5, 2010

(51) Int. Cl. C40B 30/04; C40B 50/00; C40B 40/10

(52) U.S. Cl. 506/9; 506/23; 506/18

(57) ABSTRACT

Immunoglobulin libraries are provided that contain randomly assembled FR1, CDR1, FR2, CDR2, FR3, CDR3 and FR4 sequences of heavy or light chain immunoglobulin variable regions. The libraries exhibit a degree of repertoire diversity not found in natural immune systems and can be used to express novel immunoglobulins. The libraries can be used for screening antibodies with the target specificity of interest. The resultant antibodies can be fully human and non-immunogenic.

### PRIORITY

This application claims the benefit of U.S. Provisional Application Ser. No. 60/906,108, filed Mar. 9, 2007, the contents of which are incorporated by reference herein in their entirety.

### FIELD OF THE INVENTION

The present invention relates to the creation of an antibody library that carries a repertoire diversity exceeding the natural immune system and existing combinatorial technologies. The library can be used to screen for antibodies with a specificity of interest, and an antibody thus generated will be considered fully functionally human.

### BACKGROUND

Monoclonal antibodies represent a class of therapeutics with demonstrated clinical efficacies and safety profiles. Although the original breakthrough in hybridoma technology that occurred in the mid-1970's had given hope to the medical community for the emergence of disease specific “magic bullets,” it was not until the advent of other complementary technologies, such as antibody chimerization (see, e.g., U.S. Pat. No. 4,816,567, which is incorporated herein by reference in its entirety) and humanization (see, e.g. U.S. Pat. Nos. 5,225,539; 5,585,089; 5,693,762; 5,693,761, all or which are incorporated herein by reference in their entirety) of rodent antibodies, phage-display combinatorial libraries (Clackson et al., Nature, 352:624-628 (1991); Felici et al., J. Mol. Biol., 222:301-310 (1991); Markland et al., Gene, 109-13-19 (1991)), transgenic mice that produce human antibodies (e.g. U.S. Pat. Nos. 6,075,181; 6,150,584, all of which are incorporated herein by reference in their entirety, U.S. Pat. No. 7,041,870, which is incorporated herein by reference in its entirety), and other production technologies that the concept of magic bullet has been realized. As such, the anti-CD20 antibody, rituximab, is considered to be the holy grail of antibody-based therapeutics. There are currently at least 19 therapeutic antibodies approved by the U.S. Food and Drug Administration (FDA), and hundreds of antibody candidates being evaluated at various stages of clinical trials.

Primarily, an antibody works by first binding to its target antigen at a unique and specific site. It exerts its therapeutic response either by blocking undesirable interactions with the target cells (for example, ReoPro (abciximab), Remicade (infliximab), Humira (adalimumab)) or by inducing immune effector functions to eliminate unwanted cells, such as tumors (for example, Rituxan (rituximab), Herceptin (trastuzumab), Campath-1 (alemtuzumab)). Because of its target specificity, others have used antibodies as the delivery vehicle to bring payloads of chemical drugs (for example, Mylotarg (gemtuzumab)) or radionuclides (Zevalin (ibritumomab), Bexxar (tositumomab)) to the target cells to effect cytotoxic elimination. The unique target specificities, proven clinical efficacies and safety profiles of therapeutic antibodies have opened up unlimited possibilities for achieving optimal disease diagnosis, therapy, and other industrial applications.

### Antibody Diversity:

One of the major strengths of antibodies is the repertoire diversity on target specificity an antibody can achieve. This is done through processes of genetic recombination and somatic mutations.

Mice and humans have three multi gene families found on different chromosomes that encode immunoglobulin chains (Table 1).

TABLE 1
The Chromosomal Location of Immunoglobulin Genes

Chromosome

| Gene | Mouse | Human |
|---|---|---|
| Light Chain | 6 | 2 |
| Light Chain | 16 | 22 |
| Heavy Chain | 12 | 14 |

Each family contains coding sequences called gene segments. The light chain is encoded by three distinctive gene segments: variable (V) gene segments (roughly 300 base-pairs long), joining (J) gene segments (roughly 50 base-pairs long), and constant (C) gene segments (roughly 300 base-pairs long). All of these gene segments are separated by variable lengths of non-coding DNA. The embryonic forms of λ- and κ-chain (and heavy-chain) genes also include a DNA sequence coding for a 19 amino acid leader preceding each V-gene segment. Light chain V-gene segments encode amino acid residues 1 to 95 (including CDR1 and CDR2), J-gene segments encode amino acid residues 96 to 108 (including the CDR3), and C-gene segments encode the remainder of the chain (FIG. 1A). In humans, there are roughly 100 V genes available to recombine with five J genes. It is at the VJ joining site where most immunoglobulin diversity is created (FIG. 2). The affinity and specificity of an antibody can be further enhanced through a maturation process where somatic mutations are introduced along the variable region sequences (composed of VJ recombination). Most of the mutations (deletions, additions, and sequence changes) are found in the CDR3 motif. The human lambda chain gene structure comprises roughly 100 V genes, and six J genes (FIG. 1A). The spatial arrangement of the V and J genes for the lambda chain is slightly different from that of the kappa chain, but the remainder of the recombination scheme is very similar.

The organization of heavy-chain gene segments is similar to that of the light chain; however, the heavy-chain gene segments also contain diversity-(D) gene segments (roughly 50 base-pairs long), and each C-region gene segment has one or more associated coding segments called membrane (M) exons. As for light chains, each V-gene segment is preceded by a leader sequence. Heavy chains are encoded by four different gene segments: VH, DH, JH, and CH. Heavy chain V-gene segments encode amino acid residues 1 to 101 (including CDR1, and CDR2), D-gene segments encode amino acid residues 102 to 106 (preceding CDR3), J-gene segments encode amino acid residues 107 to 123, and C-gene segments encode the remainder of the chain (FIG. 1B). In humans, there are roughly 100 functional V genes, 25-30 functional D genes and 6 functional J genes. Repertoire diversity creation through recombination of the VDJ genes in forming the heavy chain variable region is similar to that of the light chain, except that further level of diversity at the heavy chain CDR3 is created by the presence and involvement of D-gene segments (FIG. 2).

Antibody diversity is generated at different levels, including: (a) variability in the germline repertoire, and multiplicity of V, D, and J genes; (b) combinatorial freedom at joining of the V-J genes for the light chain and joining of the V-D-J genes for the heavy chain, as well as combinatorial association of the heavy and light chains; (c) junctional diversity resulting from imprecise DNA rearrangement and insertion of random nucleotides between D- and J-derived segments in D-J or V-DJ recombination; and (d) somatic hypermutation.

Without considering the diversity achieved through somatic hypermutation, the level of diversity that can be generated can be calculated as shown in Table 2.

TABLE 2
Calculation of Baseline Antibody Diversity
Light chain gene segments

| 1. Germline repertoire | VK = 100 |
|---|---|
| | JK = 4 |
| 2. Combinatorial joining | VK × JK = 100 × 4 = 400 |
| 3. Junctional diversity | 3 |
| Total light chain genes | 3 × 400 = 1200 |

Heavy chain gene segments

| | |
|---|---|
| 1. Germline repertoire | VH = 100 |
| | VD = 12 |
| | VJ = 4 |
| 2. Combinatorial joining | VH × VD × VJ = 100 × 12 × |
| | 4 = 4800 |
| 3. Junctional diversity | 9 |
| Total light chain genes | 4800 × 9 = 43200 |

Furthermore, the baseline diversity can be increased by combinatorial association. The combination of heavy chain genes with light chain genes results in 1200×43200=5.1×10⁷ possible immunoglobulins. Thus, the estimated diversity that can be generated from the human immune system, without taking somatic hypermutation into consideration, is 5.1×10⁷.

### Antibody Re-Engineering Technologies:

The technical breakthrough that led to the clinical success of therapeutic antibodies comes from the advent of antibody engineering capabilities, such as chimerization and humanization. This technology allows the conversion of most murine-derived antibodies into human forms without significantly altering the antigen specificity and affinity of the parent antibodies.

Chimerization (see, for example, U.S. Pat. No. 4,816,567) takes the approach of transplanting the heavy and light chain variable regions of a murine antibody onto a human constant region. Therefore, a chimeric antibody contains one third of its sequence in murine form, and in theory, can be immunogenic upon repeated administration into humans.

The conventional humanization approach (see, for example, U.S. Pat. Nos. 5,225,539; 5,585,089; 5,693,762; 5,693,761) aims to reduce the percentage of murine sequences by grafting the complementarity-determining-region (CDR) sequences of the parent antibody onto acceptor human framework sequences. The resultant humanized antibody sequence usually will contain less than 10% residues of murine origin. However, this approach is not without deficiencies. First, the CDRs are usually derived from murine antibodies, and are major sources of foreignness (immunogenicity). Secondly, direct grafting of CDRs onto a human framework usually will result in the loss of antibody affinity and specificity. Although this loss can be rescued by identifying framework residues that might interact with the antigen binding sites and by re-introducing these murine residues back into the human framework, it is not uncommon for a CDR-grafted immunoglobulin to contain more than seven back-mutated residues from the murine frameworks. The major drawback of the conventional CDR-grafting approach is that it fails to examine the level of achievable “humanness” from an immunological perspective. It does not take into consideration the possibility of generating novel T-cell immunogenic epitopes by the back-mutated murine residues within the context of the acceptor human frameworks (FIG. 3).

In order to avoid employing murine CDRs in the final antibody structure, other techniques have been developed to generate fully human antibodies. Cambridge Antibody Technologies (CAT) and Dyax have obtained antibody cDNA sequences from peripheral B cells isolated from immunized humans and devised phage display libraries for the identification of human variable region sequences of a particular specificity. Briefly, the antibody variable region sequences are fused either with the Gene III or Gene VIII structure (Clackson et al., Nature, 352:624-628 (1991); Felici et al., J. Mol. Biol., 222:301-310 (1991); Markland et al., Gene, 109-13-19 (1991), all of which are incorporated by reference herein in their entirely) of the M13 bacteriophage. These antibody variable region sequences are expressed either as Fab or single chain Fv (scFv) structures at the tip of the phage carrying the respective sequences. Through rounds of a panning process using different levels of antigen binding conditions (stringencies), phages expressing Fab or scFv structures that are specific for the antigen of interest can be selected and isolated. The antibody variable region cDNA sequences of selected phages can then be elucidated using standard sequencing procedures. These sequences may then be used for the reconstruction of a full antibody having the desired isotype using established antibody engineering techniques. Antibodies constructed in accordance with this method are considered fully human antibodies (including the CDRs). In order to improve the immunoreactivity (antigen binding affinity and specificity) of the selected antibody, an in vitro maturation process can be introduced, including a combinatorial association of different heavy and light chains, deletion/addition/mutation at the CDR3 of the heavy and light chains (to mimic V-J, and V-D-J recombination), and random mutations (to mimic somatic hypermutation). An example of a “fully human” antibody generated by this method is the anti-tumor necrosis factor α antibody, Humira (adalimumab), a therapeutic monoclonal antibody that was recently approved by the FDA for the treatment of rheumatoid arthritis (RA).

This approach suffers from the limitation of lacking sequence diversity, as all sequences are derived originally from existing antibodies in the human, from whom mature B cells are obtained. Moreover, the introduced mutations in the in vitro maturation process can be potential sources of foreignness (giving rise to new T cell epitopes), raising questions on the claimed humanness of the library-derived antibodies.

Mice carrying human genomic immunoglobulin gene sequences generated through a series of gene knock-out and transgenic processes (e.g. U.S. Pat. Nos. 6,075,181; 6,150,584, all of which are incorporated herein by reference in their entirety (Abgenix); and U.S. Pat. No. 7,041,870, which is incorporated herein by reference in its entirety (Medarex)) represent perhaps the best source for producing fully human antibodies. These mice (e.g., the XenoMouse of Abgenix Inc., Fremont, Calif.; and the HuMAb Mouse of GenPharm-Medarex, San Jose, Calif.) can be immunized with the antigen of interest, and the antibody affinity maturation process is accomplished in a natural immune system environment. Although the V and J gene segments for the light chain, and the V, D, and J gene segments for the heavy chain are 100% human, the mutation/deletion/addition in the VJ and VDJ junction, and the somatic mutations along the variable region sequence occurring under the murine immune system might differ significantly from that of human. One cannot rule out the possibility of these mutations being potential sources of T cell epitopes under the human immune surveillance. In fact, the anti-CD20 antibody (HuMax-CD20) derived from the HuMAb Mouse of GenPharm-Medarex (San Jose, Calif.) was demonstrated to be more immunogenic than Rituximab (chimeric anti-CD20), eliciting higher incidences of infusion reactions in patients with Rheumatoid Arthritis (see Editorial Comment in abstract P0018. Ostergaard et al. 2006. First Clinical Results of Humax-CD20 Fully Human Monoclonal IgG1 Antibody Treatment in Rheumatoid Arthritis (RA). EULAR). Moreover, due to the limited size of the immunoglobulin mini gene introduced in the transgenic mice, the diversity generated may not be as great as that of the natural human immune system. Regardless, antibodies generated from these mice are considered the most human-like when compared to those generated by other existing methods.

Except for the HuMab mouse approach, most methods dealing with antibody humanness do so from a visual but not functional perspective. Attempts to make an antibody that resembles a human antibody in appearance has become the primary goal. However, from the perspective of the immune system, the immunoglobulin protein is examined and inspected by the immune system. An immunoglobulin that gets internalized into an antigen presenting cell (APC) will be proteolytically degraded into linear stretches of peptides. Some resulting peptide fragments are bound to major histocompatibility complex (MHC) class II molecules. A small number of those peptides are expressed on the cell surface as a complex with MHC molecules. Those MHC-peptide complexes evoke an effector response when recognized by the antigen-specific receptors on T cells. This triggers a cascade in which some T cells differentiate into helper T cells.

The release of cytokines induces differentiation of antigen-specific B cells into antibody-specific plasma cells (FIG. 4). Only when an immunoglobulin contains peptides viewed by the immune system as “self” will the immunoglobulin be considered fully human and survive surveillance by the immune system.

Conventional humanization by CDR-grafting cannot get rid of the murine sequences of the CDRs which are important for antigen binding specificity and affinity of the re-engineered antibody. Moreover, the back-mutation required in most CDR-grafting approaches may introduce new T cell epitopes, leading to potential immunogenicity of the CDR-grafted antibodies. Although framework re-engineering technology has mitigated or avoided the need for back-mutation (see, for example, U.S. Pat. No. 7,321,026, which is incorporated herein by reference in its entirety), the problem of inherent immunogenicity arising from the CDRs remains unresolved. Gillies et al. (e.g. see U.S. Pat. No. 6,992,174, which is incorporated herein by reference in its entirety) argue that if a protein sequence does not contain a linear peptide sequence that will be presented by host antigen presenting cells in the context of MHC II as foreign (T cell epitope), such protein sequence will be “viewed” by the host immune system as “self,” and can be used repeatedly in the host for therapeutic purposes with substantially mitigated risks of eliciting an unfavorable immune response against the protein. Gillies et al. therefore developed a procedure called “peptide threading”, using computational methods based on modeling peptide binding to MHC II to identify stretches of potentially immunogenic peptides that can be presented as foreign. The peptide threading method then converts the sequence (usually by changing one or two amino acids) into one that presumably will not be presented as foreign (i.e., is unable to bind to MHC II). By doing these exercises, any highly immunogenic protein (including, e.g., murine immunoglobulins) with therapeutic potential can in theory be rendered non-immunogenic (deimmunized) by a few mutations in the amino acid sequences (Adair F., “Immunogenicity: The last hurdle for clinically successful therapeutic antibodies,” BioPharm, 13: 42-46 (2000); Adair et al., “The immunogenicity of therapeutic proteins,” February Issue 30-36 (2002)). This approach requires a thorough understanding of the sequence requirements for a peptide to be rendered immunogenic or non-immunogenic for presentation by the MHC, and the availability of a properly designed computer program for evaluating these sequences.

In light of the foregoing, there is a need in the art for improved phage display libraries or other similar libraries, such as Ribosome-display Libraries (see for example, Hanes et al. 1998. Ribosome display efficiently selects and evolves high affinity antibodies in vitro from immune libraries. PNAS 95:14130-14135), that allow for the production of functionally humanized, non-immunogenic antibodies having specificity for a target antigen of interest. The present invention addresses this need.

### SUMMARY OF THE INVENTION

Accordingly, the present invention provides a variety of immunoglobulin sequence databases and corresponding DNA libraries. Separate databases in tangible form and DNA libraries are provided for each of the immunoglobulin light chain FR1, CDR1, FR2, CDR2, FR3, CDR3, and FR4 segments as well as for each of the immunoglobulin heavy chain FR1, CDR1, FR2, CDR2, FR3, CDR3, and FR4 segments.

It will be understood by those skilled in the art that one or more aspects of this invention can meet certain objectives, while one or more other aspects can meet certain other objectives. Each objective may not apply equally, in all its respects, to every aspect of this invention. As such, the following objects should be viewed in the alternative with respect to any one aspect of this invention.

In one aspect, the invention provides a database of immunoglobulin light chain variable region sequences in tangible form, i.e., on a storage medium, such as an electronic, magnetic, or optical storage medium, or in printed form. The database contains the amino acid sequences, or nucleotide sequences encoding such amino acid sequences, of at least 2, 5, 10, 20, 50, 100, 200, 500, 1000, 2000, 5000, or 10000 light chain variable regions of a single mammalian species. The light chain variable regions are assembled by freely associating, end to end and in the same order in which they appear in a natural light chain variable region, the sequences of FR1, CDR1, FR2, CDR2, FR3, CDR3, and FR4 segments obtained from V- and J-genes of the mammalian species, or from one or more databases or publications containing amino acid or nucleotide sequences of known immunoglobulins or immunoglobulin light chains of the mammalian species. In some embodiments, the database does not contain any sequences of light chain variable regions of known immunoglobulins of the species; for example, the database can exclude the associations of FR1-CDR1-FR2-CDR2-FR3, which are present in all of the known light chain V-genes of the mammalian species. In a preferred embodiment, the database sequences are derived from humans. In some embodiments, the database contains sequences of only kappa chains. In other embodiments, the database contains sequences of only lambda chains. In still other embodiments, the database contains sequences obtained from both kappa and lambda chains.

In a further aspect, the present invention provides a DNA library containing DNA sequences encoding at least 2, 5, 10, 20, 50, 100, 200, 500, 1000, 2000, 5000, or 10000 light chain variable region amino acid sequences of the previously described immunoglobulin light chain variable region sequence database.

In another aspect, the invention provides a database of immunoglobulin heavy chain variable region sequences in tangible form, i.e., on a storage medium or in printed form. The database contains the amino acid sequences, or nucleotide sequences encoding such amino acid sequences, of at least 2, 5, 10, 20, 50, 100, 200, 500, 1000, 2000, 5000, or 10000 heavy chain variable regions of a single mammalian species. The heavy chain variable regions are assembled by freely associating, end to end and in the same order in which they appear in a natural heavy chain variable region, the sequences of FR1, CDR1, FR2, CDR2, FR3, CDR3, and FR4 segments obtained from heavy chain V-, D-, and J-genes of the mammalian species, or from one or more databases or publications containing amino acid or nucleotide sequences of known immunoglobulins or immunoglobulin heavy chains of the mammalian species. In some embodiments, the database does not contain any sequences of heavy chain variable regions of known immunoglobulins of the species; for example, the database can exclude the associations of FR1-CDR1-FR2-CDR2-FR3 which are present in all of the known heavy chain V-genes of the mammalian species. In a preferred embodiment, the database sequences are derived from human. In some embodiments, the database contains sequences of only gamma chains. In other embodiments, the database contains sequences of other types (e.g., γ₁, γ₂, γ₃, γ₄, μ, α₁, α₂, δ, or ε) of heavy chains. In still other embodiments, the database contains sequences obtained from any possible mixture of the above mentioned heavy chain types.

In a further aspect, the present invention provides a DNA library containing DNA sequences encoding at least 2, 5, 10, 20, 50, 100, 200, 500, 1000, 2000, 5000, or 10000 heavy chain variable region amino acid sequences of the previously described immunoglobulin heavy chain variable region sequence database.

In another aspect, the present invention provides a database of single chain Fv (scFv) immunoglobulin sequences in tangible form. The database contains the amino acid sequences, or nucleotide sequences encoding such amino acid sequences, of at least 2, 5, 10, 20, 50, 100, 200, 500, 1000, 2000, 5000, or 10000 scFv, each scFv consisting essentially of a light chain variable region of a mammalian species joined by a linker sequence to a heavy chain variable region of the same mammalian species. The light chain variable regions are assembled by freely associating, end to end and in the same order in which they appear in a natural light chain variable region, the sequences of FR1, CDR1, FR2, CDR2, FR3, CDR3, and FR4 segments obtained from V- and J-genes of the mammalian species, or from one or more databases or publications containing amino acid or nucleotide sequences of known immunoglobulins or immunoglobulin light chains of the mammalian species. The heavy chain variable regions are assembled by freely associating, end to end and in the same order in which they appear in a natural heavy chain variable region, the sequences of FR1, CDR1, FR2, CDR2, FR3, CDR3, and FR4 segments obtained from heavy chain V-, D-, and J-genes of the mammalian species, or from one or more databases or publications containing amino acid or nucleotide sequences of known immunoglobulins or immunoglobulin heavy chains of the mammalian species. In some embodiments, the database does not contain any sequences of either light chain or heavy chain variable regions of known immunoglobulins of the species; for example, the database can exclude the associations of FR1-CDR1-FR2-CDR2-FR3 which are present in all of the known light chain and heavy chain V-genes of the mammalian species. In a preferred embodiment, the database sequences are derived from human. In some embodiments, the scFv sequences in the database contain light chain sequences of only kappa chains. In other embodiments, the scFv of the database contain light chain sequences of only lambda chains. In still other embodiments, the scFv light chain sequences contain sequences obtained from both kappa and lambda chains. In some embodiments, the scFv sequences in the database contain heavy chain sequences of only gamma chains. In other embodiments the scFv of the database contain sequences of other types (e.g., γ₁, γ₂, γ₃, γ₄, μ, α₁, α₂, δ, or ε) of heavy chains. In still other embodiments, the scFv of the database contain heavy chain sequences obtained from any possible mixture of the above mentioned heavy chain types.

In yet another aspect, the present invention provides a phage display library expressing at least a portion of the scFv contained in the aforementioned scFv database.

The invention further provides a non-naturally occurring immunoglobulin. The immunoglobulin contains either a light chain variable region sequence from the above described light chain variable region database, or a heavy chain variable region sequence from the above described heavy chain variable region database. The immunoglobulin can also be an scFv whose sequence is contained in the above described scFv sequence database, or an scFv that is expressed by the above described phage display library.

In still another aspect, the present invention provides a method of preparing the aforementioned immunoglobulin light chain variable region database. A further object of the present invention is to provide a method of increasing the diversity of the library by adding one or more nucleic acid sequences that encode an immunoglobulin light chain variable region amino acid sequence.

In yet another aspect, the present invention provides a method of preparing the aforementioned immunoglobulin heavy chain variable region database. A further object of the present invention is to provide a method of increasing the diversity of the library by adding one or more nucleic acid sequences that encode an scFv amino acid sequence.

In yet another aspect, the present invention provides a method of preparing the aforementioned immunoglobulin scFv database. Yet another object of the invention is to provide a method of increasing the diversity of the library by adding one or more nucleic acid sequences that encode an immunoglobulin light chain variable region amino acid sequence.

In yet another aspect, the present invention provides a method of preparing the aforementioned phage display library. In one embodiment, the present invention provides a method for producing a human immunoglobulin phage display library and a human immunoglobulin phage display library so produced, the method comprising the steps of:

preparing a first set of nucleotide sequences, the sequences encoding human immunoglobulin light chain variable regions, wherein the sequences of the first set comprise sequences of human light chain cDNA segments encoding FR1, CDR1, FR2, CDR2, FR3, CDR3, and FR4, wherein the segments are randomly selected and ligated to encode a light chain variable region comprising in order FR1-CDR1-FR2-CDR2-FR3-CDR3-FR4;

preparing a second set of nucleotide sequences, the sequences encoding human immunoglobulin heavy chain variable regions, wherein the sequences of the second set comprise sequences of human heavy chain cDNA segments encoding FR1, CDR1, FR2, CDR2, FR3, CDR3, and FR4, wherein the segments are randomly selected and ligated to encode a heavy chain variable region comprising in order FR1-CDR1-FR2-CDR2-FR3-CDR3-FR4;

preparing a third set of nucleotide sequences, the sequences encoding single chain Fv immunoglobulins, wherein the sequences of the third set comprise a light chain sequence from said first set, a linker, and a randomly selected heavy chain sequence from the second set, wherein the linker covalently joins the light chain sequence and the heavy chain sequence such that the sequences of the third set encode single chain Fv immunoglobulins; and

incorporating the third set of nucleotide sequences into a phagemid cloning vector to form a phage display library.

In the context of the above-described method, it may be preferable for the human light chain cDNA segments of the first set of nucleotide sequences to encode only kappa chains. Alternatively, the human light chain cDNA segments of the first set of nucleotide sequences may encode only lambda chains. Alternatively, the human light chain cDNA segments of the first set of nucleotide sequences may encode both kappa and lambda chains. Similarly, the human heavy chain cDNA segments of the second set of nucleotide sequences may encode only gamma chains, only sequences of γ₁, γ₂, γ₃, γ₄, μ, α₁, α₂, δ, or ε heavy chains, or a combination thereof.

In an optional preferred embodiment, the phage display library of the present invention, prepared by the above-described method, excludes the associations of FR1-CDR1-FR2-CDR2-FR3.

A further object of the present invention is to provide a method of identifying an antigen binding molecule. The method includes the step of panning an expression library that expresses an immunoglobulin containing either a light chain variable region sequence contained in the aforementioned immunoglobulin light chain variable region database or a heavy chain variable region sequence contained in the aforementioned immunoglobulin heavy chain variable region database. In some embodiments, the method involves panning the aforementioned scFv library. The panning process may also involve testing the expressed immunoglobulins for binding to a selected antigen. The result of the panning process is the identification of an immunoglobulin that binds the selected antigen.

These and other objects and features of the invention will become more fully apparent when the following detailed description is read in conjunction with the accompanying figures and/or examples. However, it is to be understood that both the foregoing summary of the invention and the following detailed description are of preferred embodiments and not restrictive of the invention or other alternate embodiments of the invention. In particular, while the invention is described herein with reference to a number of specific embodiments, it will be appreciated that the description is illustrative of the invention and is not constructed as limiting of the invention. Various modifications and applications may occur to those who are skilled in the art, without departing from the spirit and the scope of the invention, as described by the appended claims. Likewise, other objects, features, benefits and advantages of the present invention will be apparent from this summary and certain embodiments described below, and will be readily apparent to those skilled in the art having knowledge of antibody design and antibody library construction. Such objects, features, benefits and advantages will be apparent from the above in conjunction with the accompanying examples, data, figures and all reasonable inferences to be drawn there-from, alone or with consideration of the references incorporated herein.

### BRIEF DESCRIPTION OF THE DRAWINGS

Other features and advantages of the present invention will be apparent from the following detailed description of the invention, taken in conjunction with the accompanying drawings of which:

FIG. 1 shows the organization of germline immunoglobulin for human (A) κ and λ, chains, and (B) heavy chains.

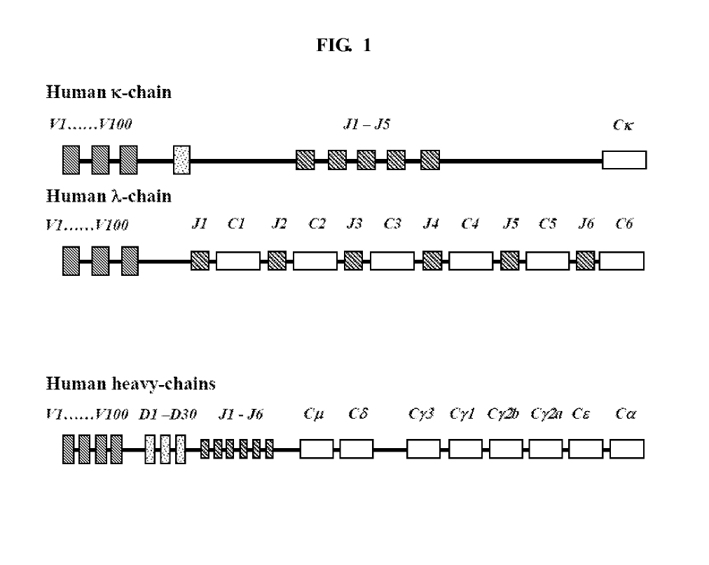

FIG. 2 shows the relationship between immunoglobulin (Ig) gene segments (exons) and light and heavy (λ) chain domains. The Ig light chain is encoded by two incomplete, or segmented, exon (V and J) and one complete exon (C). The Ig heavy chain, here the membrane form of the μ chain, is encoded by three incomplete, or segmented, exons (V, D and J) and six complete exons (C₁₋₄, and the transmembrane (TM) and cytoplasmic (CY) exons). The approximate locations of intrachain and interchain disulfide bridges (S—S), or carbohydrates (•) and of CDRs (shaded boxes) are given.

FIG. 3 is an illustration of the process of humanization by conventional CDR-grafting technology. Only CDR-grafting of the heavy chain variable region is shown.

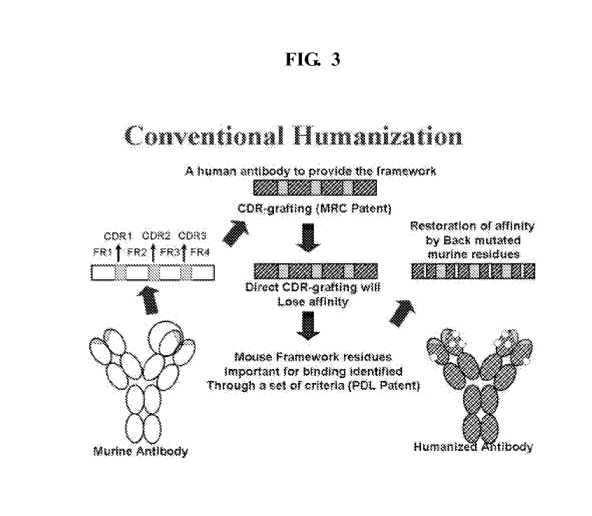

FIG. 4 shows how a conventionally humanized antibody may be functionally foreign under surveillance of the human immune system. Although a CDR-grafted antibody containing back-mutated murine framework residues (∘) may have a visually human appearance, the antibody when internalized by an antigen presenting cell (APC) will be proteolytically degraded into short peptides. These short peptides, when fit into the binding groove of MHC II complex, will be presented to T helper cells. When a peptide containing a back-mutated murine framework residue appears as a new T cell epitope, its presentation to a T helper cell via MHC II will result in the activation of the T helper cell, leading to a cascade of immune responses against the CDR-grafted antibody.

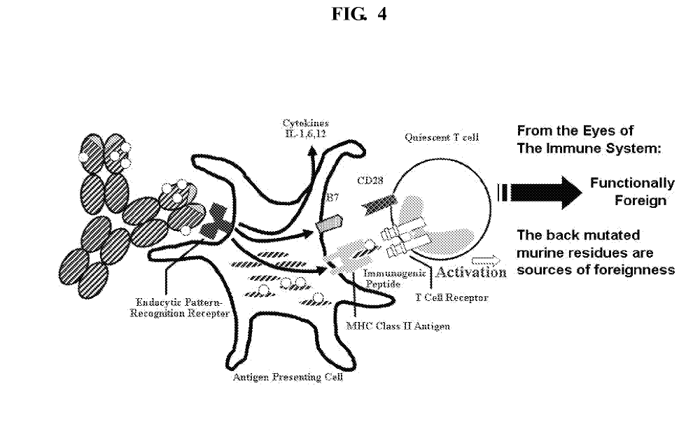

FIG. 5 shows the generation of repertoire diversity through free-assortment of FR1, CDR1, FR2, CDR2, FR3 and CDR3 segments from five different V-genes and one J-gene. Only recombination of VL is illustrated.

FIG. 6 shows the generation of repertoire diversity through V-J gene recombination from five different V-genes and one J-gene. Only recombination of VL is illustrated.

FIG. 7 depicts the light chain variable region nucleotide and amino acid sequences of CA9. CDRs are boxed.

FIG. 8 depicts the sequence alignment for the VK region of CA9 and other human sequences. (A) Nucleotide sequence alignment; (B) Amino acid sequence alignment. CDRs are boxed.

FIG. 9 depicts the results of electrophoresis gel (1% Agarose) analysis of PCR products retrieved from sequential oligonucleotide V region ligation. Lanes 1-4, PCR amplification of sequential oligonucleotide V region ligation in wells containing 12.5, 25, 50 and 100 μmole of immobilized FR4. Bands of the right size (˜320 bp) were found. Lane 5, size marker. Wells of negative control contained no immobilized FR4 and gave no bands (not shown).

FIG. 10 depicts an assay method for evaluating the functional activities of TNF-α (Part A) which can induce cell cytotoxicity of L929 cells and demonstrating (Part B) how a neutralizing antibody, such as chimeric CA9 can inhibit TNF-α-induced L929 cell cytotoxicity in a dose dependent manner.

FIG. 11 compares the neutralizing activities of an scFv-phage containing the original CA9 VK and VH sequence (control scFv phage) and an scFv-phage clone containing a VK sequence obtained from the mini-diverse VK library and a VH from the original CA9 (scFv (VK library/VH CA9) phage) at different dilutions. Mock phage contains no scFv sequences.

### DETAILED DESCRIPTION OF THE INVENTION

This present invention constitutes a marked improvement in the field of phage display libraries (or similar libraries, such as the ribosome-display libraries) for the production of functionally humanized antibodies. In particular, the present invention provides a variety of immunoglobulin sequence databases and corresponding DNA libraries. Separate databases in tangible form and DNA libraries are provided for each of the immunoglobulin light chain FR1, CDR1, FR2, CDR2, FR3, CDR3, and FR4 segments as well as for each of the immunoglobulin heavy chain FR1, CDR1, FR2, CDR2, FR3, CDR3, and FR4 segments.

Although any methods and materials similar or equivalent to those described herein can be used in the practice or testing of embodiments of the present invention, the preferred methods, devices, and materials are now described. However, before the present materials and methods are described, it is to be understood that this invention is not limited to the particular compositions, methodologies or protocols herein described, as these may vary in accordance with routine experimentation and optimization. It is also to be understood that the terminology used in the description is for the purpose of describing the particular versions or embodiments only, and is not intended to limit the scope of the present invention which will be limited only by the appended claims.

Unless otherwise defined, all technical and scientific terms used herein have the same meaning as commonly understood by one of ordinary skill in the art to which this invention belongs. In case of conflict, the present specification will control.

In the context of the present invention, the words “a”, “an”, and “the” as used herein mean “at least one” unless otherwise specifically indicated.

As noted above, the present invention provides a method of preparing a phage display library, more particularly a human immunoglobulin phage display library constructed to have maximized repertoire diversity. Phage display libraries have well recognized utility in identifying novel antigen binding molecules. Specifically, by diversifying the initial immunoglobulin gene repertoire included in the library and by expressing these potentially functional fragments on phage, antibodies to any specificity can be isolated very quickly through panning, a process conventional in the art of library screening. The process of panning against antibody-displaying phage can be automated, using for example AutoPan®. CysDisplay™ technology provides simple elution of high-affinity binders and reduces the number of potential candidates to several hundreds or thousands of sequences. These candidates can then be screened in a robust 384-well ELISA (AutoScreen®). Positive clones can be automatically forwarded for further validation, sequenced, and entered in the central database.

As used herein, an “immunoglobulin” refers to a protein consisting of one or more polypeptides substantially encoded by immunoglobulin genes. A typical immunoglobulin protein contains two heavy chains paired with two light chains. A full-length immunoglobulin heavy chain is about 50 kD in size (approximately 446 amino acids in length), and is encoded by a heavy chain variable region gene (about 116 amino acids) and a constant region gene. There are different constant region genes encoding heavy chain constant region of different isotypes such as alpha, gamma (IgG1, IgG2, IgG3, IgG4), delta, epsilon, and mu sequences. A full-length immunoglobulin light chain is about 25 Kd in size (approximately 214 amino acids in length), and is encoded by a light chain variable region gene (about 110 amino acids) and a kappa or lambda constant region gene. Naturally occurring immunoglobulin is known as antibody, usually in the form of a tetramer consisting of two identical pairs of immunoglobulin chains, each pair having one light and one heavy chain. In each pair, the light and heavy chain variable regions are together responsible for binding to an antigen, and the constant regions are responsible for the effector functions typical of an antibody.

The materials and methods of the present invention may be utilized to identify and isolate novel, fully human and non-immunogenic immunoglobulins. In the context of the present invention, a fully human antibody will have to have the following characteristics:
(1) significantly reduced, more preferably eliminated immunogenicity, thereby allowing multiple injection of the antibody for human uses;
(2) minimally perturbed immunoreactivity including specificity and affinity (within 3-fold) against the original antigen;
(3) capable of inducing human effector functions such as complement fixation, complement-mediated cytotoxicity, antibody-dependent cell cytotoxicity, etc.

Antibody immunogenicity may be routinely assayed using conventional technology, typically in a clinical setting using suitable subjects, for example, primates, more preferably humans. For example, the immunogenic potential of a therapeutic antibody of interest can be determined by identifying specific T cell epitopes that arise in response to administration the antibody of interest or by determining the potential of normochromatic erythrocytes (NCEs) to stimulate helper T cell responses and/or induce late onset allergy like reactions in response thereto. This process may be automated, for example using the EpiScreen™ technology commercially available through Antitope Ltd (Cambridge UK).

The novel, fully functionally human and presumably non-immunogenic immunoglobulins of the present invention will typically find use individually, or in combination with other treatment modalities, in treating diseases susceptible to antibody-based therapy. For example, the immunoglobulins can be used for passive immunization, or the removal of unwanted cells or antigens, such as by complement mediated lysis, all without substantial adverse immune reactions (for example anaphylactic shock) associated with many prior antibodies. Alternatively, the immunoglobulins of the present invention may be used for in vitro purposes, for example, as diagnostic tools for the detection of specific antigens, or the like.

A preferable usage of the immunoglobulins of the present invention will be the treatment of diseases using their naked forms (naked antibodies) at dosages ranging from 50 mg to 400 mg/m², administered either locally at the lesion site, subcutaneousely, intraveneousely, and intramuscularly, etc. Multiple dosing at different intervals will be performed to achieve optimal therapeutic or diagnostic responses, for example, at weekly intervals, once a week, for four weeks. Usage of the immunoglobulins derived from the present invention can be combined with different treatment modalities, such as chemotherapeutic drugs (for example CHOP, Dox, 5-Fu, . . . etc), radiotherapy, radioimmunotherapy, vaccines, enzymes, toxins/immunotoxins, or other immunoglobulins derived from the present invention or others. For example, if the immunoglobulins of the present invention is specific for the idiotype of an anti-tumor antibody, it may find utility can as a tumor vaccine for the elicitation of Ab3 against a tumor antigen. Numerous additional agents, or combinations of agents, well-known to those skilled in the art may also be utilized.

Additionally, the immunoglobulins of the present invention can be utilized in different pharmaceutical compositions. The immunoglobulins can be used in their naked forms, or as conjugated proteins with drugs, radionuclides, toxins, cytokines, soluble factors, hormones, enzymes (for example carboxylesterase, ribonuclease), peptides, antigens (as tumor vaccine), DNA, RNA, or any other effector molecules having a specific therapeutic function with the antibody moiety serving as the targeting agents or delivery vehicles. Moreover, the immunoglobulins or immunoglobulin derivatives, such as antibody fragments, single-chain Fv, diabodies, etc. of the present invention can be used as fusion proteins to other functional moieties, such as, immunoglobulins or immunoglobulin derivatives of a different invention (for example as bispecific antibodies), toxins, cytokines, soluble factors, hormones, enzymes, peptides, etc. Different combinations of pharmaceutical composition, well-known to those skilled in the art may also be utilized.

The materials and methods of the present invention may be utilized to screen for antibodies having binding specificity for a target antigen interest. As noted previously, the novel, fully human and non-immunogenic immunoglobulins of the present invention may have diagnostic and/or therapeutic utility. Accordingly, the present invention is not limited in terms of the antigen of interest. Examples of antigens of interest suitable for use in the context of the present invention include, but are not limited to, the CD41 7E3 μlycoprotein IIb/IIIa receptor on the platelet membrane (associated with cardiovascular disease), TNF (associated with inflammatory conditions), CD52 (associated with chronic lymphocytic leukemia), IL-2a (associated with transplant rejection), VEGF (associated with macular degeneration and colorectal cancer), EGF (associated with colorectal cancer), complement system protein C5 (associated with inflammatory conditions), CD3 receptor (associated with transplant rejection), T cell VLA4 receptor (associated with autoimmune-related multiple sclerosis), CD11a (associated with inflammatory conditions such as psoriasis), CD20, CD22, CD19, Invariant Chain Ii (associated with non-Hodgkins lymphoma and possibly autoimmune diseases), CD33 (associated with acute myelogenous leukemia), IgE inflammatory (associated with allergy-related asthma therapy), the F protein of RSV (associated with RSV), ErbB2 (associated with breast cancer), CEA (associated with colorectal cancer, breast cancer and a variety of tumors), Mucin (associated with breast cancer, pancreatic cancer), CD147 (associated with liver cancer), and beta-amyloid protein (associated with Alzheimer's disease).

The ability of an expressed immunoglobulin to bind a target antigen of interest may be assayed using conventional technology, for example, direct or competition cell binding assays (e.g., cell-based ELISA and/or flow cytometry), ELISA assays (e.g., wherein ELISA plates are coated with the antigen of interest and binding of the antibody directly on to the antigen coated plates is measured using colorimetric methods), Biacor assays (e.g., measuring the affinity of an antibody to a particular antigen), and the like.

The diagnostic and/or therapeutic utility of an immunoglobulin of the present invention may be assayed and confirmed using conventional technology, for example, through the elicitation of complement-mediated cytolysis (CMC), or Antibody Dependent Cell Cytotoxicity (ADCC) on cells expressing the antigen of interests, or by blocking the activity of a particular enzyme or functional protein (for example, blocking cell proliferations of interleukine dependent cell lines with antibodies specific for a particular interleukin).

Generation of a Functionally Human Antibody Library with High Repertoire Diversity:

Previous approaches, such as CDR-grafting, have successfully reduced the immunogenicity of antibodies used for human treatment. Nevertheless, the possible diversity of such antibodies is limited by the number of available human framework sequences and by the need to identify a single, naturally occurring V-gene framework sequence (containing FR1, FR2 and FR3) that demonstrates high sequence homology to the parent antibody. Using the method of the present invention, however, an immunoglobulin can be re-engineered such that when broken into peptides and presented to the host immune system, such an immunoglobulin will be viewed as “functionally human” (i.e., essentially non-immunogenic in a human host).

Structurally and functionally, an immunoglobulin variable region is divided into seven stretches of linear sequences, namely, FR1, CDR1, FR2, CDR2, FR3, CDR3, and FR4. The binding affinity and specificity of an immunoglobulin depends largely on the sequences of CDR1, CDR2 and CDR3, and these CDRs form the physical boundaries dividing the different FRs. Although the framework regions are considered to be important for forming the scaffold supporting the CDR structures, amino acids within these framework regions sometimes interact with the CDRs and influence the binding affinity/specificity of the resultant protein.

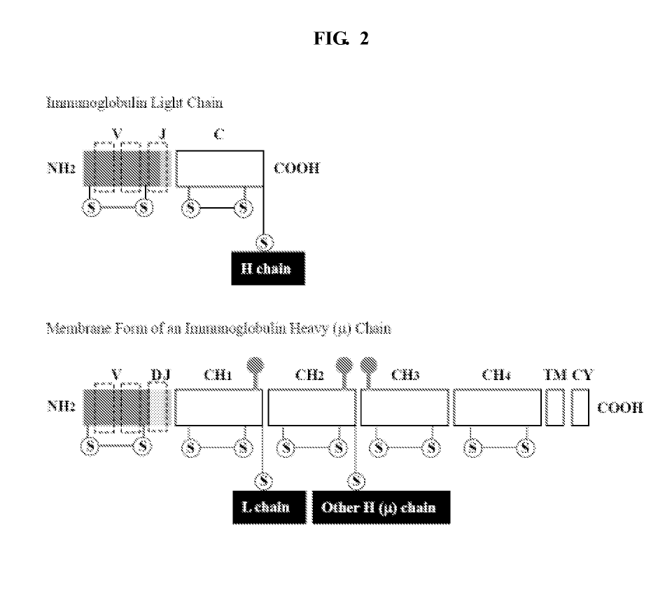

The FR1, CDR1, FR2, CDR2, and FR3 segments of a variable region of a naturally occurring immunoglobulin are not genetically separable, but are encoded within a single V-gene (FIG. 2). However, through the intervention of molecular biology techniques, the nucleic acid sequences encoding the FR1, CDR1, FR2, CDR2, and FR3 segments can be isolated from a collection of different V-genes, e.g., human V-genes. Similarly, nucleic acid sequences that encode the CDR3/FR4 portion of an immunoglobulin variable region can be obtained from a collection of different J-genes.

Thus, in one embodiment, the present invention provides a library containing nucleic acid sequences encoding immunoglobulin light chain variable regions. The library contains sequences assembled at random from V-gene sequence segments that independently encode the FR1, CDR1, FR2, CDR2, and FR3 segments and J-gene sequence segments encoding the CDR3 and FR4 segments of a light chain variable region. The sequences are assembled into a collection of nucleic acid molecules, each of which contains randomly-selected segments assembled to encode, in order, the FR1, CDR1, FR2, CDR2, FR3, CDR3, and FR4 amino acid sequences of an immunoglobulin light chain variable region.

In another embodiment, the present invention provides a library containing nucleic acid sequences encoding immunoglobulin heavy chain variable regions. The library contains sequences assembled at random from V-gene sequence segments that independently encode the FR1, CDR1, FR2, CDR2, and FR3, and partial CDR3 segments, D-gene sequence segments encoding partial CDR3 segments, and J-gene sequence segments encoding partial CDR3 and FR4 segments of a heavy chain variable region. The sequences are assembled into a collection of nucleic acid molecules, each of which contains randomly-selected segments assembled to encode, in order, the FR1, CDR1, FR2, CDR2, FR3, CDR3, and FR4 amino acid sequences of an immunoglobulin heavy chain variable region.

The sequences for a library of the present invention may be obtained from mammalian V-, D-, and J-genes, or from the known nucleotide or amino acid sequences of mammalian immunoglobulins. Preferably, all the sequences are obtained from a single mammalian species. More preferably, all the sequences are obtained from human gene sequences or human immunoglobulin sequences. A library of the present invention can contain nucleic acid sequences that have been modified from naturally occurring gene sequences according to the degeneracy of the genetic code or to perform certain desired mutations, e.g., mutations required to ensure appropriate folding of the immunoglobulin polypeptide chain or to maintain or improve antigen binding specificity.

When the immunoglobulin sequence segments are derived from, e.g., a collection of human V-genes and J-genes of a different human immunoglobulin, the resultant re-engineered immunoglobulin protein will still be viewed by the human immune system as being functionally human. First, since each segment (including the CDRs) is of human origin, and has already been “screened” by a human immune system to be non-immunogenic, there is no need to go through the tedious “peptide threading process” to identify potentially immunogenic stretches, and decide which amino acid to convert in order to render them non-immunogenic. Second, the free assortment of framework regions and CDRs from different human antibody V-genes creates a repertoire diversity not achievable by the natural recombination process. Therefore, a library constructed by freely assorted human FR1, CDR1, FR2, CDR2, FR3, CDR3 and FR4 segments not only yields immunoglobulins that are functionally human, but also yields a library of immense diversity that, depending on the size of the pool of human immunoglobulin sequences, can potentially exceed our natural human capacity.

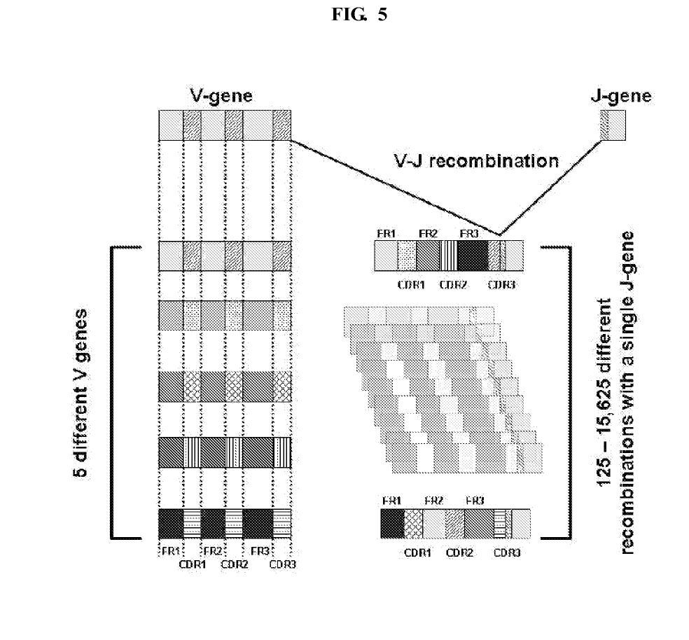

The present invention describes the construction of a library of immunoglobulins composed of freely assorted segments of the immunoglobulin variable region sequences, namely, the FR1, CDR1, FR2, CDR2, FR3, CDR3, and FR4 (FIG. 5). A resultant immunoglobulin obtained from such a library will be functionally human.

The repertoire diversity that can be generated from 5 V-genes and one J gene using the present invention can be calculated as follows:
Scenario 1: All combinations generated from free assortments of framework regions and CDRs are taken into consideration contributing to repertoire diversity=5(FR1)×5(CDR1)×5(FR2)×5(CDR2)×5(FR3)×5(CDR3)×1(FR4)=5⁶=15,625
Scenario 2: Since framework regions do not contribute much to antigen specificity and affinity, and are not taken into consideration for the generation of repertoire diversity, only combinations of CDR assortments are calculated for repertoire diversity generation=5(CDR1)×5 (CDR2)×5(CDR3)=125

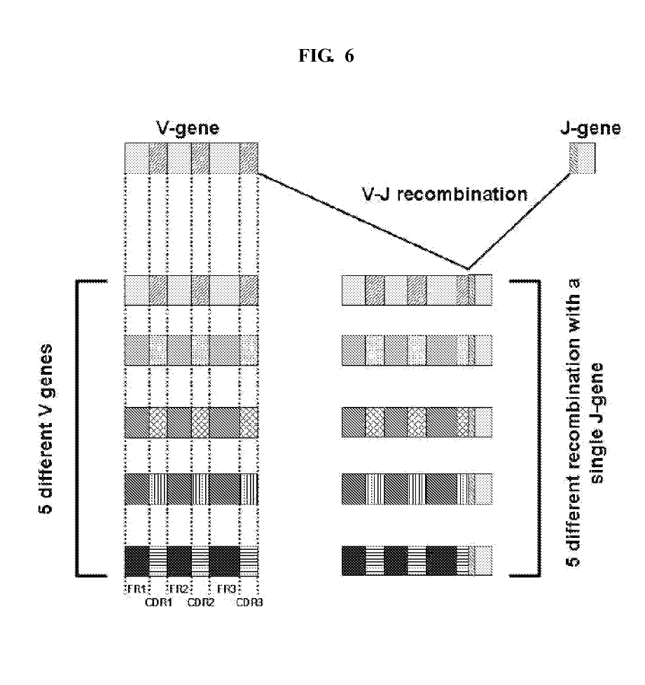

Therefore, the repertoire diversity generated from 5 V-genes and one J-gene using the current invention ranges from 125 to 15,625 (FIG. 5). This compares favorably against the natural immune system in which the repertoire diversity that can be generated is only five (FIG. 6).

Previously, it has been determined that the diversity achievable in the natural human immune system is 5.1×10⁷ (not including diversity achieved via somatic hypermutation). Given a library containing freely assorted human FR1, CDR1, FR2, CDR3, FR3, CDR3, and FR4 from 100 human heavy and light chain V-gene sequences, one can estimate the level of diversity that can be achieved with three different scenarios:
Scenario 1: FR and CDR diversities are calculated=100⁶=10¹² for each chain Combinatorial association=10¹²×10¹²=10²⁴
Scenario 2: CDRs from both heavy and light chains are calculated=200³=2×10⁶ Combinatorial association=2×10⁶×2×10⁶=4×10¹²
Scenario 3: CDRs from corresponding chains are calculated=100³=10⁶ Combinatorial association=10⁶×10⁶=10¹²

In Scenario 1, the combination of different FR segments with different CDRs is counted to be contributory to diversity generation. The diversity generated will be the highest (10²⁴); however, because FR segments form the scaffold supporting the CDRs, they might not contribute as much diversity as the CDRs. Scenario 2 does not consider framework regions to be contributory to the resultant diversity, but allows free association of corresponding CDRs from heavy and light chains. For example, the heavy chain CDR1 can be used in place of the light chain CDR1 in the construction of the light chain library. The diversity achievable in such a library will be 4×10¹². In less favorable conditions, in which CDRs from the heavy chain can only be used in its corresponding position in the corresponding chain (i.e. CDR1 of heavy chain can only be used in position for CDR1 in the construction of the heavy chain library), the diversity that can be achieved will be 10¹². The diversity generated in anyone of these scenarios using only 100 V-gene sequences for the heavy and light chain well exceeds that achievable in the natural immune system (5.1×10⁷).

Given a large enough human antibody sequence database, there will be supplies of numerous linear stretches of FR1, CDR1, FR2, CDR2, FR3, CDR3, and FR4 for both the heavy and light chain immunoglobulin variable region sequence. The diversity created should, in theory, at least match that of the natural system.

In fact, there are roughly 170 human heavy chain and 170 human light (kappa+lambda) chain variable region sequences available in the existing database (Kabat's database). Using the above three scenarios, the diversity range generated from such a library will be 2.4×10¹³−1.68×10³¹. By continually expanding the size of libraries of antibody FR and CDR segments, a functionally human antibody library with exceptionally high diversity can be constructed.

An antibody library in accordance with the present invention, prepared by randomly combining sequence segments selected from sequences encoding FR1, CDR1, FR2, CDR2, FR3, CDR3, and FR4, can be assembled either at one time, or in stages. Thus, if only a limited number of individual FR1, CDR1, FR2, CDR2, FR3, CDR3, and FR4 sequences are available at a given time, these can be used to assemble an initial library, which can be expanded when additional sequences become available. The present invention also contemplates a method of increasing the diversity of an immunoglobulin library by adding to a library according to the invention one or more nucleic acid sequences that encode an immunoglobulin light chain variable region, heavy chain variable region, or scFv amino acid sequence, assembled according to the methods described above.

Human immunoglobulin libraries can be obtained from human donors of different ethnic groups or having certain diseases. Similar databases can be constructed from different primates, immunized with antigens of interest (e.g. AIDS).

The nucleotide sequences contained within each of the above libraries of the invention can be entered into a database and stored in tangible form, e.g., on a storage medium or in printed form. The storage medium can be, for example, an electronic, magnetic, or optical storage medium, or any storage medium capable of use with a computer for retrieval. A database of the invention in tangible form can also be associated with a computer. For example, such a computer can comprise instructions that are stored in memory and executed by the processor. A person of ordinary skill in the art can also appreciate that a database of the invention can be accessed and manipulated by a processor executing a computer instruction in, for example, the form of scripts, compiled programs or any other suitable components such as downloadable applets or plug-ins. A set of instructions or programs defining system functions can be delivered to a processor in many forms. Exemplary forms can include permanently stored information on a non-writable storage media such as read only memory devices of a computer that can be readable with an input-output attachment, information alterably stored on writable storage media such as floppy disks, a hard drive, or a flash drive, information conveyed to a computer through communication media or any other type of suitable forms that are contemplated by a person of ordinary skill within the art.

Hereinafter, the present invention is described in more detail by reference to exemplary embodiments. However, the following examples are offered only to illustrate aspects of the invention and are in no way intended to limit the scope of the present invention. As such, embodiments similar or equivalent to those described herein can be used in the practice or testing of the present invention.

### Example 1

### Generation of a cDNA Database for Human Antibodies

Plasma cells and matured B cells are isolated from either the tonsil or peripheral blood of human donors. Tumor infiltrating B cells/plasma cells can be obtained directly from resected tumors. Solid tissue is first manually disaggregated in DMEM (Gibco, Rockville, Md.). This and all later steps are performed in conditions with maintenance of low temperature, and minimal, gentle handling to minimize cell lysis, a significant source of mRNA contamination of single cells. Both disaggregated tissues and blood samples are purified by centrifugation on a cool Ficoll gradient (Histopaque 1083, Sigma, St Louis, Mo.) for 20 min. at 2500 r.p.m. and 4° C. in a Sorvall benchtop centrifuge in order to enrich for plasma cells and lymphocytes. Samples can be stored at −80° C. in 10% DMSO until use. Cells are washed once in cold PBS, and pelleted at 2000 r.p.m. for 2 min. Plasma cells are stained with FITC-conjugated mouse anti-human CD38 (Caltag, Burlingame, Calif.) at a 1:50 dilution in DMEM (Gibco) for 15 min. at 4° C. IgG+ B cells are stained with FITC-conjugated mouse anti-human IgG, Fe-specific (Caltag). Cells are washed once with PBS, collected by a 2 min. spin at 2000 r.p.m., re-suspended in PBS and isolated by FACS (MOFLO cell sorter, Cytomation, Fort Collins, Colo.). FACS selection of the top 15% of CD38 expressing cells yields virtually pure plasma cells (Merville et al., J. Exp. Med., 183, 227-236 (1996)). Selection of B cells requires no such stringency, as no other cell types express surface Ig.

There are numerous methods for obtaining the V-region sequences of human immunoglobulin cDNA. Basically, anti-sense primers specific for the constant region sequences of the human gamma heavy chain, and kappa and lambda light chains are used to generate the first-strand cDNA, and the V-regions of these cDNA are amplified using a set of specific or degenerate primers that encompass most of the V-gene sequences. Amplification of the V-gene sequences can be done through standard RT-PCR procedures (with sets of nesting primers) (Li et al., “Effect of VL and VH consensus sequence-specific primers on the binding and expression of a mini-molecule antibody directed towards human gastric cancer,” Chin Med Sci J., 15:133-139 (2000); Coronella et al., “Amplification of IgG VH and VL (Fab) from single human plasma cells and B cells,” NAR 28, No 20 e85 (2000); Wang et al., “Human immunoglobulin variable region gene analysis by single cell RT-PCR,” J Immunol Methods, 20:244:217 (2000)); or oligonucleotide-assisted cleavage and ligation (ONCL) (Schoonbroosdt et al., “Oligonucleotide-assisted cleavage and ligation: a novel directional DNA cloning technology to capture cDNAs,” Application in the construction of a human immune antibody phage-display library, Nucl. Acid Res., 19:33(9):e81 (2005)). There are variations in the method of obtaining V-region cDNA sequences, and the examples given below are offered by way of illustration, not by limitation.

### Reverse Transcription:

Cells (plasma cells and/or matured B cells) are spun briefly (30 s) to collect liquid and cells in the bottom the of wells. Plates must be kept cooled in this and all subsequent steps. The work area and pipettes are sterile, and separate from the PCR work area. To each well is added 5 μl cold RT buffer B (1 μl 0.1% Igepal CA-630 (Sigma), 1 μl oligo-d(T)16 (Perkin Elmer, Norwalk, Conn.), 0.25 μl DNase I-treated yeast tRNA (Boehringer Mannheim, Indianapolis, Ind.), 1 μl 5× first strand buffer, 0.5 μl of 40 U/μl RNAsin (Promega, Madison, Wis.), 1.5 μl DEPC H₂O). RT plates are heated to 65° C. for 1 min, cooled to 55° C. for 30 s, 45° C. for 30 s, 35° C. for 30 s, 23° C. for 2 min, then 4° C. in a PTC-100 Thermocycler (MJ Research Inc., Waltham, Mass.). An aliquot of 5 μl of cold buffer C (1 μl 10 mM dNTP mix (Gibco), 1 μl 5× first strand buffer, 1 μl Superscript II RnaseH-reverse transcriptase (Gibco), 2 μl DEPC H₂O) is then added to each well, for a total reaction volume of 20 μl RT is performed at 42° C. for 90 min.

### First PCR Reaction:

Three PCR reactions are run per sample; one for lambda light chain (λ), one for kappa light chain (κ) and one for gamma heavy chain (γ). Ready-To-Go beads (Pharmacia, Piscataway, N.J.) in 96-well plates are used for all subsequent PCR reactions. Each reaction uses 0.5 μl of each 20 μM 5′ primer, 0.5 μl of a 20 μM 3′ constant region primer, H₂O to 25 μl, and 5 μl single cell cDNA. Groups of 5′ primers are as described in Sblattero and Bradbury (Sblattero et al., Immunotechnology, 3:271-278 (1998)), to which terminal restriction sites are added for the purpose of cloning. 3′ constant region primers (CL2: CGCCG[TCTAGA]ACTATGAACATTCTGTAG (SEQ ID NO:1) for λ, constant region; CK1Z: GCGCCG[TCTAGA]ACTAACACTCTCCCCTGTTGAAGCTCTTTGTGACGGGCGATC TCA (SEQ ID NO:2) for R constant region; CG1Z: GCATCT[ACTAGT]TTTGTCACAAGATTTGGG (SEQ ID NO:3) for IgG1 hinge) are as described by Burton and Barbas (Burton et al., Adv Immunol., 59: 191-280 (1994)). Primers for cloning the different V-region sequences are as described in Coronella et al. (2000. NAR. 28:E85) and can be used in the following settings: λ: 0.5 μl each VL1B, VL3B, VL38B, VL4B, VL7/8B, VL9B, VL11B, VL13B, VL15B; 0.5 μl CL2, 20 μl H₂O, 5 μl cDNA. 0.5 μl each VK1B, VK2B, VK9B, VK12B; 0.5 μl CK1Z, 22.5 μl H₂O, 5 μl cDNA. γ: 0.5 μl each VH4B, VH5B, VH6B, VH10B, VH12B, VH14B, VH22B; 0.5 μl CG1Z, 21 μl H₂O, 5 μl cDNA.

The first PCR reactions are run at 94° C. for a 4 min. initial hot start, followed by 35 cycles of 94° C. for 1 min. (denaturation), 55° C. for 2 min. (annealing) and 72° C. for 3 min. (elongation). A final 1 min. elongation was performed at 72° C.

Alternatively, primers specific for IgA, IgM or IgD constant region sequences of different allotypes can be used to PCR amplify V region sequences of IgA, IgM or IgD immunoglobulins, respectively.

### Second PCR Reaction:

The products of the first PCR reactions are used as templates for a second nested PCR (second PCR). Each reaction contains 0.5 μl 5′ variable region primer, 0.5 μl 3′ constant region primer, 24 μl of H₂O, 1 μl of the appropriate first PCR reaction and uses a PCR-Ready-To-Go bead. Nested 3′ primers for λ(Lnest: GC[TCTAGA]ACTAATGCGTGACCTGGCAGCTGT) (SEQ ID NO:4), κ(Knest: GC[TCTAGA]ACTAA TGGGTGACTTCGCAGGCGTAGAC) (SEQ ID NO:5) and IgG heavy chain (Hcnest: GG[ACTAGT]GTTGCAGATGTAGGTCTGGGTGC) (SEQ ID NO:6) are used in the second PCR.

Amplification is as for the first PCR, but with a 60° C. annealing step.

### Sequence Analysis:

An aliquot of 5 μl of each second PCR product is analyzed by agarose gel electrophoresis. The second PCR products are purified (Qiagen Qiaquik, Valencia, Calif.) and cloned directly into TA cloning vectors (Invitrogen). The sequences of the cloned cDNA are elucidated by an automated sequencing method using TA cloning vector specific primers (Perkin Elmer ABI Prism dye termination system). Sequences of cDNA are translated into amino acid sequences using the McVector DNA analyzer software, and the amino acid sequences are compared with the Kabat Database to determine whether they are of immunoglobulin origin. All immunoglobulin V-region sequences are divided according to the Kabat's classification into FR1, CDR1, FR2, CDR2, FR3, CDR3 and FR4 sub-segments. Both the cDNA sequence encoding the sub-segments, and the amino acid sequence of the sub-segments are then entered into a database, compiling a collection of framework regions and CDRs sub-libraries.

### Example 2

### Construction of a Human V-Region Library Containing Freely Assorted Framework Regions and CDRs

A sub-library of different heavy and light chain FR1, CDR1, FR2, CDR2, FR3, CDR3 and FR4 coding sequences may be generated from the Kabat database (Kabat et al., “Sequences of Proteins of Immunological Interest,” (5th Edition), US Dept Health and Human Services, US Government Printing Offices (1991)) as illustrated in Example 1.

All FR and CDR segments may be assembled from chemically synthesized oligonucleotides. Briefly, complementary DNA oligonucleotides of a particular sequence segment are chemically synthesized. Equimolar concentrations of the complementary oligonucleotides are mixed under annealing conditions to form blunt-end double stranded DNA segments. Sequence segments for different framework regions and CDRs derived from the database are kept either frozen or lyophilized for future use. When the sub-library size reaches the target diversity number, a library of V-region sequences is assembled en bloc sequentially in the proper order, i.e. FR1-CDR1-FR2-CDR2-FR3-CDR3-FR4.

Assembly of VH and VL genes starts with the immobilized FR4 sense strand. Oligonucleotides encoding FR4 are immobilized on a gel pad or a chip. Briefly, a matrix of glass-immobilized gel elements is prepared by polymerization of 20 μm thick polyacrylamide (8% acrylamide/0.28% bisacrylamide) gel on a glass surface treated by Bind-Silane (LKB). Strips of the gel are removed in x-y directions with a scribing machine, forming the array of the gel elements of the size 40×40 μm or 100×100 μm and spaced by 80 or 200 μm, respectively. The polyacrylamide gel is activated by substitution of some amide groups with hydrazide groups by hydrazine-hydrate treatment. The glass space between the gel elements is rendered hydrophobic by treatment with Repel-Silane (LKB). Oligodeoxynucleotides for immobilization are synthesized with 3′-terminal 3 methyluridine, activated by oxidizing with NaIO₄ to produce dialdehyde groups for coupling with the hydrazide groups of the gel. The solution of activated oligonucleotides is transferred onto the micromatrix element with a one-pin robot. After the transfer, the matrix temperature is decreased, and water is condensed on the gel. The fully swollen gel matrix is covered by oil (Nujol mineral oil, Schering-Plough) and kept at 20° C. for 48 hr for oligonucleotide immobilization; then the oil is washed out by ethanol and distilled water. The microchip is dried and can be kept at 4° C. for 1 year before use. See, for example, Yershov et al. 1996. Proc. Natl. Acad. Sci. USA, 93, 4913-4918.

The FR4 sense strand is presynthesized and then immobilized on the solid support (Khrapko et al., FEBS Lett., 256:118-122 (1989); Khrapko et al., DNA Seq., 1:375-388 (1991); Lamture et al., NAR, 22:2121-2125 (1994); Ghu et al., NAR, 22:5456-5465 (1994)). Alternatively, the FR4 sense strand may be directly synthesized on a solid support (Southern et al., Genomics, 13:1008-1017 (1992); Fodor et al., Science, 251:767-773 (1991); Pease et al., PNAS, 91:5022-5026 (1994)). In situ annealing and ligation is then performed on the immobilized sequence.

One picomole of FR4 sense strand oligonucleotide (oligo) is immobilized on the gel pad (100 fmol per 0.1×0.1×0.002 mm pad). Annealing is carried out in 10 μl hybridization buffer containing 1 μM anti-sense FR4 (unphosphorylated). The solution containing the anti-sense oligo is kept at 90° C., and a 10 μl drop of the hot hybridization solution is placed on the chip and incubated for 5 min. at room temperature (under cover glasses). Un-annealed oligos are washed off with distilled water for 10 min. at 37° C. All anti-sense oligos (except that for FR4) are phosphorylated at its 5′ end before they are used to form double stranded DNA of the remaining framework regions and CDRs with their sense strand counterparts (unphosphorylated). Phosphorylation is carried out in 10 μl reaction mixture containing 1×PN kinase buffer (Epicentre Technologies, USA), 500 pmol ATP and 0.5 U T4 polynucleotide kinase (Epicentre Technologies, USA) at 37° C. for 60 min. This will ensure directional blunt end ligation in the proper order and sequence (only the phosphorylated 5′ end of the sense strand can ligate with the immobilized sequence). Ligation reactions are carried out under similar conditions. Briefly, four microliters of CDR3 ligation mixture containing 4 pmol of blunt end-annealed CDR3 double strand DNA and 1 U T4 DNA ligase (Boehringer Mannheim, USA) in 0.5× dilution and 1× ligation buffer (Rapide DNA Ligation kit, Boehringer Mannheim, USA) are placed on the chip. The ligation is carried out at room temperature for 12 hr at 100% humidity. Un-ligated CDR3DNAs are washed off. And the ligation-wash cycle is repeated with double-stranded FR3, CDR2, FR2, CDR1 and FR1 in a sequential manner.

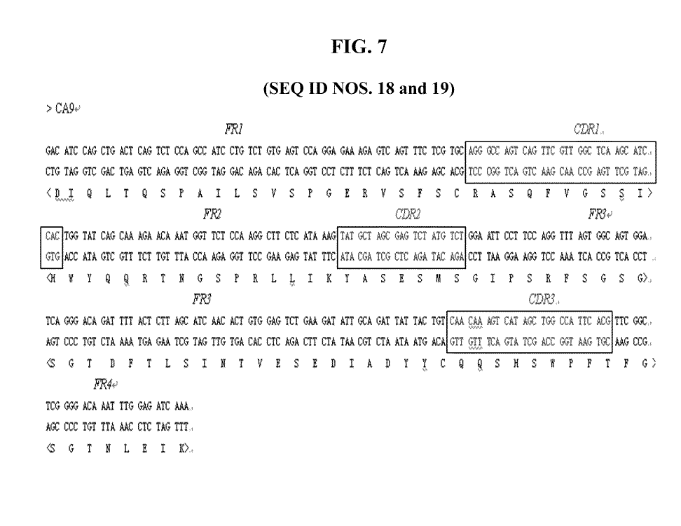

Alternatively, the ligation may be done sequentially, by directional sticky end cloning. FIG. 7 illustrates a proposed scheme. Again, except for the FR4, the anti-sense strands of all FR and CDR segments are phosphorylated to ensure directional ligation. However, double stranded DNAs with overhang structures are introduced. FR4 with a 5′ overhang with three staggered nucleotides is made (FIG. 7). For the double stranded CDR3, the phosphorylated anti-sense will have three protruding 5′ overhang carrying degenerate nucleotides (A/T/G/C)(A/T/G/C)(A/T/G/C) (indicated by XXX) beyond the CDR, and three protruding 3′ overhang with defined sequences (indicated by OOO) from the CDR. The defined 5′ overhang sequence on the FR4 sense strand enables the selection of the proper sequence from the degenerate 5′ overhang of the CDR3 sequence to anneal, and then ligate. Moreover, the incompatible upstream overhang structure of the CDR3 double stranded DNA and the asymmetrical phosphorylation (only at the anti-sense) ensures a directional, sticky end ligation. CDR3 carrying degenerate sequences that cannot anneal and ligate with the defined overhang sequences of FR4 are washed off. For ligation of the FR3, the unphosphorylated sense strand has three protruding 3′ overhangs carrying degenerate nucleotides beyond the FR3 sequence, and three protruding 5′ overhangs carrying defined FR3 sequences. Using similar alternating strategies, the ligation can be carried out in an efficient, and directional manner (FIG. 7).

A universal overhang sequence is incorporated at the upstream position of all FR1 segments, and at the downstream position of all FR4 segments, so as to facilitate subsequent linker sequence joining and sub-cloning into the final expression system. For example, in a VH-linker-VL alignment, an Sfi1 site is incorporated at the upstream position of the FR1 universal sequence overhang, and a NotI incorporated at the downstream position of the FR4 universal overhang to facilitate cloning into a phagemid vector such as pCANTAB 5E. These sequences can be incorporated into a phage-display library in the form of either scFv or Fab (Cai et al., PNAS, 93:6280-6285 (1996); Barbas et al., PNAS, 89:10164-10168 (1992)). Alternatively, they can be incorporated into the ribosome-display system for screening (Hanes et al., PNAS, 95:14130-14135 (1998); Schaffitzel et al., I Immunol Methods, 231: 119-135 (1999)).

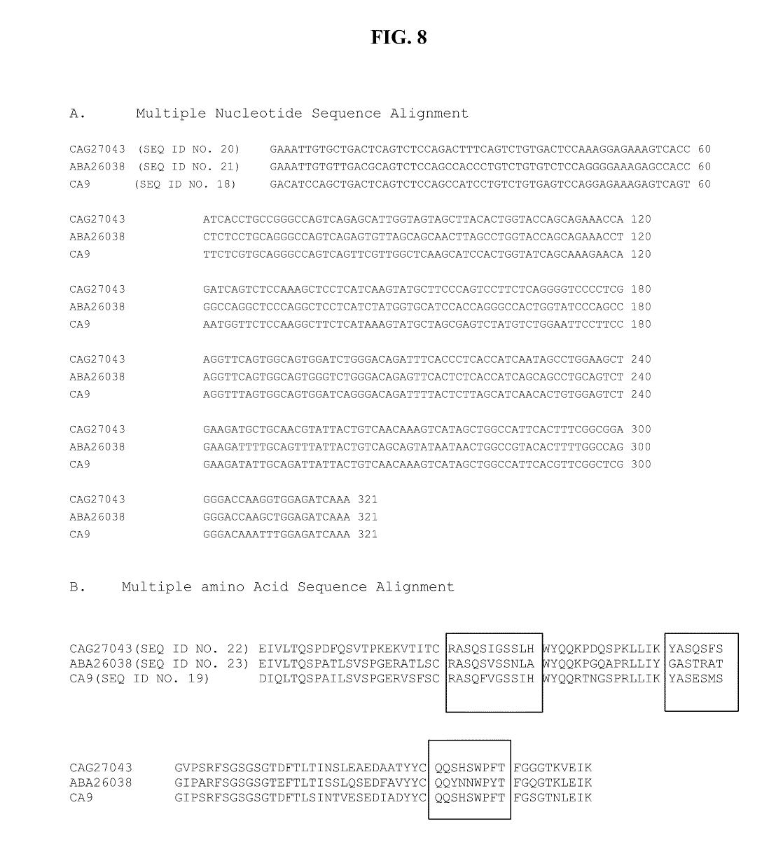

Optionally, a universal primer sequence may be incorporated at the upstream position of all FR1 segments, and at the downstream position of all FR4 segments, so as to facilitate subsequent linker sequence joining and subcloning into the final expression system. For example, in a VH-linker-VL alignment, a Sfi1 site with the sequence of 5′-GAATTC GGCCCAGCCGGCC-3′ (SEQ ID NO:7) is incorporated at the upstream position of all VH FR1 sequences, and a partial linker sequence (5′-GGCACCACGGTCACCGTC-3′) (SEQ ID NO:8) incorporated at the downstream position of all VH FR4 sequences (FIG. 8). Similarly, a partial linker sequence (5′-GCTCACTCAGTCTCCA-3′) (SEQ ID NO:9) is incorporated at the upstream position of all VL FR1 sequences, and a NotI containing sequence (5′-GCGGCCGCAGGTGCGCCG-3′) (SEQ ID NO:10) incorporated at the downstream position of all VL FR4 segments. Primer A (5′-GAATTC GGCCCAGCCGGCC-3′) (SEQ ID NO:11) and Primer B (5′-GACGGTGACCGTGGTGCC-3′) (SEQ ID NO:12) are used to PCR-amplify all assembled VH sequences; and Primer C (5′-GCTCACTCAGTCTCCA-3′) (SEQ ID NO:13) and Primer D (5′-CGGCGCACCTGCGGCCGC-3′) (SEQ ID NO:14) can be used to PCR-amplify all assembled VL sequences (FIG. 8). The joining of PCR-amplified VH and VL sequences is facilitated by standard overlapping PCR. The VH-linker-VL PCR products are restriction digested with Sfi1 and NotI for subsequent subcloning into the pCANTAB 5E phagemid vector. Other phagemid vectors can be used. The VH and VL sequences are incorporated into a phage-display library in the form of scFv (optionally Fab) (Cai et al., PNAS, 93:6280-6285 (1996); Barbas et al., PNAS, 89:10164-10168 (1992)). Another option is to incorporate VH and VL into a ribosome-display system for screening (Hanes et al., PNAS, 95:14130-14135 (1998); Schaffitzel et al., I Immunol Methods, 231:119-135 (1999)).

### Example 3

### Construction of a Phage Display Library

Variable immunoglobin (Ig) sequences VH and VL that are assembled from different FR and CDR segments (see Example 2) are joined together to form a DNA sequence encoding a single chain variable fragment (scFv) of an antibody by overlap PCR, using primers specific for the universal overhangs incorporated upstream and downstream of the assembled VH and VL sequences. The VH and VL sequences are joined via a peptide linker with the sequence of (GGGGS)3 (SEQ ID NO:15) (other linker sequences and lengths are possible). See FIG. 8.

PCR is carried out in 50 μl of reaction volume containing 1×PCR buffer (Invitrogen); 1.5 mM MgCl₂ (Invitrogen); 0.2 mM dNTP (Promega); 0.04 U/μl of Platinum Taq polymerase (Invitrogen); 50 ng of synthetic Ig genes V_{H} or V_{κ}, respectively, and 0.2 μM primers. After a 3-min. pre-denaturing step at 94° C., 25 extension cycles are carried out in a Mastercycler® personal PCR thermocycler with a 25-well aluminum plate (Eppendorf). Each cycle consists of denaturation at 94° C. for 40 s, annealing at 50° C. for 40 s, and extension at 72° C. for 40 s, followed by a 10-min. post-extension step at 72° C., and 5 μl of PCR product of each linker-linked VH and VL used as template for the overlap PCR.

The overlap PCR is carried out in 50 μl of reaction mixture containing 1×PCR buffer (Invitrogen), 2.5 mM MgCl₂ (Invitrogen), 0.2 mM dNTP (Invitrogen), 0.04 U/μl of Platinum Taq polymerase (Invitrogen), 5 μl of PCR products of the first-step PCR (both V_{H} and V_{κ}), and 0.2 μM of flanking primers. The mixture is pre-denatured at 94° C. for 3 min., followed by 25 extension cycles with a Mastercycler® personal PCR thermocycler with 25-well aluminum plate (Eppendorf). Each cycle consists of denaturation at 94° C. for 60 s, annealing at 50° C. for 60 s, and extension steps at 72° C. for 60 s. After an extended incubation at 72° C. for 10 min., the PCR product (DNA encoding an scFv) is stored at 4° C. until use.

After overlap PCR, single chain variable fragments (scFv) is purified by QIAquick PCR Purification Kit (Qiagen). The purified PCR products are subjected to Sfi I digestion in 1× NEBuffer 2 (New England Biolabs) supplemented with 0.01% BSA (1×NEB-BSA, New England Biolabs), 5 U of Sfi I restriction enzyme, and 1 ug of purified scFv DNA in a reaction volume of 50 μl. The reaction mixture is incubated at 37° C. overnight. After Sfi I digestion, the digested product is purified by QIAquick Nucleotide Removal Kit (Qiagen) and then subjected to Nod digestion in 1× NEBuffer 3 (New England Biolabs) supplemented with 0.01% BSA (1×NEB-BSA, New England Biolabs), 5 U of NotI restriction enzyme, and purified Sfi I-7 digested scFv DNA in a reaction volume of 50 μl. The reaction mixture is incubated overnight at 37° C. The Sfi I/Not I-digested scFv DNA is gel-purified (QIAquick Gel Extraction Kit; Qiagen) for subsequent sub-cloning steps.

Phagemid pCANTAB 5E (Amersham) is linearized by Sfi I and Not I double digestion, for sub-cloning of the digested scFv sequences into the corresponding sites. Ligation is then carried out in 1×T4 ligation buffer (Invitrogen) with a vector:insert molar ratio of 1:3 and with a total DNA concentration of <100 ng.

The ligated DNA constitutes an scFv library (scFv-pCANTAB 5E) which is introduced into E. coli TG1 (Stratagene) by electroporation. Briefly, 2 μl of scFv-pCANTAB 5 E is mixed with 20 μl of TG1 electroporation-competent cells (Stratagene) and placed in a sterile electroporation cuvette (0.1-cm-gap) (BioRad). After pulsing the sample once at 2000V, 25 μF, and 200Ω, 1 ml of SOC medium is added to resuspend the cells. The cells are then transferred to a sterile 14-ml BD Falcon polypropylene round-bottom tube (BD Biosciences) and incubated at 37° C. for 1 hr with shaking at 250 rpm.

All transformed cultures are pooled, and transformation efficiency (or library size) is determined by spreading a serial dilution (1×, 1O⁻¹×, 1O⁻²×, and 1O⁻³×) of transformed cells onto SOBAG plates (SOBG medium with 1.5% Bacto-agar (BD Bioscience) and 100 μg/ml ampicillin (Sigma)), and incubating at 30° C. overnight.

The remaining culture is centrifuged at 4,000 rpm at 4° C. for 5 min. The cell pellet is re-suspended in 10 ml of SOBG medium containing 100 μg/ml ampicillin and 5 mM MgCl₂ and then incubated on ice for 15 min. with gentle occasional shaking. The number of cells is determined by spectrophotometry at 600 nm, (OD₆₀₀ of 0.4 equals 10⁸ cells/ml).

M13KO7 helper phage (Amersham) is added to the cell suspension at a multiplicity of infection (moi) ratio of 3:1, and the infection of M13KO7 helper phage is carried out at 37° C. for 30 min. without shaking and then at 37° C. for 30 min. with shaking at 200 rpm. After incubation, the infected culture is centrifuged at 4,000 rpm at 4° C. for 10 min. and the cell pellet is resuspended in 10 ml of 2×-YT medium containing 100 μg/ml ampicillin and 50 μg/ml kanamycin. Rescue efficiency is determined by spreading a serial dilution (1×, 1O⁻¹×, 1O⁻²×, and 1O⁻³×) of cell suspension onto SOBAG-K plate (SOBG medium with 1.5% Bacto-agar, 100 μg/ml ampicillin, and 50 μg/ml kanamycin), and incubating at 37° C. overnight (>20 hr). The remaining cell suspension is made up to 50 ml with 2×-YT medium containing 100 μg/ml ampicillin and 50 μg/ml kanamycin, and incubated at 37° C. overnight with shaking at 250 rpm for recombinant scFv-phage production.

### Example 4

### Panning of scFv Phage-Displayed Library for a Specific Antigen

The overnight culture obtained in Example 3, is incubated on ice for 15 min. and then centrifuged at 6,000×g at 4° C. for 10 min. The recombinant scFv-phage containing supernatant is transferred into a 50-ml ice-cold centrifuge tube, followed by the addition of 5 ml of PEG/NaCl (20% polyethylene glycol, PEG, M.W. 8000 (Sigma), and 2.5 M NaCl (Sigma)) per 25 ml of supernatant. After incubation on ice for 1.5 hr, the mixture is centrifuged at 10,000×g at 4° C. for 30 min. to collect the precipitated recombinant phages. The phage pellet is resuspended in 2 ml of 2×-YT medium containing 1% BSA. To determine scFv-phage titer, 2 μl of resuspended recombinant phages is taken out and serially diluted with 200 μl of 2×-YT medium (1O⁻²×, 1O⁴×, 1O⁻⁶×, 1O⁻⁸×, and 1O^{-10×}). From each dilution, 2 μl of diluted recombinant phage is taken out and added into 200 μl of log-phase E. coli TG1, which is then incubated at 37° C. for 30 min. (without shaking) for recombinant phage infection.

Log-phase TG1 is prepared by inoculating 10 ml of 2×-TY medium containing 5 mM MgCl₂ with 100 μl of TG1 overnight culture. The inoculum is incubated at 37° C. (with shaking at 250 rpm) until OD₆₀₀ absorbance between 0.4 and 0.5. The bacterial culture is then pre-chilled on ice for 20 min. before use. After recombinant phage infection, 100 μl of TG1 infected cells are spread onto SOBAG plates (SOBG medium with 1.5% Bacto-agar, and 100 μg/ml ampicillin), and incubated at 30° C. overnight.

For the remaining concentrated recombinant phage, 2 volumes of scFv-phage blocking buffer (1×PBS, 0.2% Triton X-100 (Sigma), 0.01% NaN₃ (Riedel-de Haën), 0.1% BSA (Sigma), and 10% non-fat milk (Nestle)) is added. After pre-blocking at room temperature for 30 min, 0.5 ml of diluted recombinant phage in blocking buffer is added into each well of 24-well culture plate (Corning) coated with the antigen of interest. Antigens can be coated onto PVC microtiter plates by adding 50 μl of antigen in PBS, and incubating the microtiter plate for 2 hr at room temperature in a humid atmosphere. Unbound antigen can be washed off the plate with PBS. See, for example, Harlow E and Lane D. 1988. In: Antibodies: A Laboratory Manual. p. 564. CSHL Press.

Pre-blocked plates are prepared one day before the experiment by dissolving the antigen of interest in carbonate coating buffer, pH 9.6, (15 mM Na₂CO₃ (Sigma) and 35 mM NaHCO₃ (Sigma)) in a final concentration of 10 μg/ml of antigen and with each well coated with 1 ml of the antigen-containing carbonate coating buffer. After overnight incubation at 4° C. with gentle shaking, each well is washed 3 times with 3 ml of borate washing buffer at pH 8.0 (26 mM Na₂B₄O₇ (BDH), 100 mM H₃BO₃ (Sigma), 0.1% BSA (Sigma), 100 mM NaCl (Sigma), 3 mM KCl (Sigma), and 0.5% Tween-20 (USB)). After washing, each well is blocked with 2.5 ml of the same buffer at 37° C. for 2 hr, and then 3 washes with 3 ml of borate washing buffer before panning.

Panning is performed by incubation at room temperature for 2 hr with gentle shaking. After the removal of unbound scFv-phage, the wells are washed with 1×PBS for 5 times with vigorous shaking for 30 s each time. The wells are then washed 10 times with 2.5 ml PBS containing 0.1% Tween-20 (USB). After washing, bound scFv-phages are eluted with a 10 minute-incubation of 100 μl of 0.1 M glycine-HCl, pH 2.2. After elution, the acid is immediately neutralized with 10 μl of 1 M Tris-HCl, pH 8.0.

All the eluted scFv-phages are pooled and transferred into 50 ml of log-phase E. coli TG1 containing 2% glucose and 5 mM MgCl₂ for re-infection. Re-infection is carried out at 37° C. for 30 min. without shaking and then 30 min. at 37° C. with shaking at 200 rpm. The titer of panning output is determined by spreading 100 μl of re-infected TG1 culture onto a SOBAG plate at a dilution of 1×, 1O¹×, 1O⁻²×, and 1O⁻³×, and then incubating at 30° C. overnight.

The remaining re-infected culture is rescued with M13KO7 helper phage by adding a final concentration of 100 μg/ml ampicillin and 5×10⁹ pfu/ml M13KO7 helper phage into the re-infected culture. Super-infection is carried out for 30 min. at 37° C. without shaking and then 30 min. at 37° C. with shaking at 200 rpm. Rescued culture is placed on ice for 10 min. and then centrifuged at 4,000 rpm at 4° C. for 10 min. The rescued cell pellet is re-suspended in 50 ml of 2×-YT medium containing 100 μg/ml ampicillin, and 50 μg/ml kanamycin. The titer of next round panning input is determined by spreading 100 μl of rescued culture, in serial dilutions of 1×, 1O⁻¹×, 1O⁻²×, and 1O⁻³×, onto SOBAG-K plate, and incubated at 37° C. overnight (>20 hr). The remaining rescued culture is incubated with shaking at 250 rpm at 37° C. overnight to produce recombinant phage for the next round of panning and the panning process is repeated twice, with a 10-fold reduction of antigen concentration coated in each round of panning.

After two rounds of panning, the screening process is completed by re-infection of the eluants of the second round with 50 ml of log-phase TG1 culture containing 2% glucose and 5 mM MgCl₂. The mixture is then incubated at 37° C. without shaking and then 37° C. with shaking at 200 rpm. Panning output is determined by spreading 100 μl of re-infected culture onto a SOBAG plate in 1×, 1O⁻¹×, 1O⁻²×, and 1O⁻³× dilutions. The remaining re-infected culture is recovered by centrifugation at 4,000 rpm at 4° C. for 10 min. and the cell pellet is resuspended in 8 ml of 2×-YT medium with 20% glycerol (Sigma) and then stored at −70° C. in aliquots.

The antigen specificity of the recombinant phage from each individual clone is analyzed by phage-ELISA, of which 1 ml of 2×-YT medium containing 2% glucose, 5 mM MgCl₂, and 100 μg/ml ampicillin is inoculated with a single colony of TG 1 obtained from the second round of panning (the panning output). After 4-5 hr of incubation at 37° C. with shaking at 250 rpm, 100 μl of the culture is removed for making glycerol stock and stored at −70° C.

The remaining culture is rescued with M13KO7 helper phage by adding 2×10⁸ pfu of M13KO7 into bacterial culture and incubating at 37° C. without shaking, then 37° C. with shaking at 200 rpm to help infection. After centrifugation at 4,000 rpm at 4° C. for 10 min, the cell pellet is resuspended in 2.5 ml of 2×-YT medium containing 100 μg/ml ampicillin and 50 μg/ml kanamycin. The culture is incubated with shaking at 250 rpm at 37° C. overnight for recombinant phage production. The overnight culture is centrifuged at 4,000 rpm at 4° C. for 15 min. The scFv-phage containing supernatant is harvested and stored at 4° C., and used for phage-ELISA assay.

Phage-ELISA is carried out in a 96-well ELISA plate, which is coated with 50 μl of carbonate coating buffer, pH 9.6, containing 50 μg of antigen. After overnight incubation at 4° C., the wells are washed 3 times with 200 μl of borate washing buffer, pH 8.0, and then blocked with 200 μl of the same buffer at 37° C. for 1 hr. After blocking, the wells are washed 3 times with 200 μl of borate washing buffer and 100 μl of scFv-phage containing supernatant is added to each well, which is then incubated at 37° C. for 1 hr.

After incubation, the wells are washed 5 times with 200 μl of borate washing buffer, pH 8.0 and then incubated with 100 μl of 5,000 fold-diluted (in borate washing buffer) horseradish peroxidase conjugated anti-M13 mouse antibody (HRP/anti-M13 mouse Ab, Amersham). After one hour of incubation at 37° C. and three washes with 200 μl of borate washing buffer, 100 μl of a-phenylenediamine (OPD, from Sigma) substrate solution is added for color development.

Substrate solution is prepared by dissolving 10 mg of OPD in 10 ml of citric phosphate buffer, pH 5.0 (24 mM citric acid (Sigma), 51 mM Na₂HPO₄ (Sigma)), with 8 μl of 30% H₂O₂ (BDH). After color development at room temperature for 1 hr, the reaction is stopped by adding 100 μl of 40% H₂SO₄ (Sigma). The color intensity is measured at absorbance 450 nm with a Sunrise micro-plate reader (Tecan). Potential phage candidates are identified by selecting those with an ELISA reading of 1.5 fold more than the mean value of the sample set. The identified candidates are later subjected to further analysis by phage-ELISA in the presence of control antigen (BSA) and nucleotide sequence determination.

### Example 5

### Conversion of Leads from a Positive Phage Library into a Functional Antibody

The DNA sequences of the scFv in scFv-Phages that are positive for the antigen of interest are elucidated. The VH and VL sequences of the selected scFv-Phages are PCR-amplified using sequence specific-primers with the appropriate cloning sites incorporated. The VH and VL sequences are then sub-cloned into their corresponding staging vectors.

Two plasmid vectors are prepared for construction and expression of the functionally human antibody genes. The plasmid pEgamma1 contains a human IgG promoter and enhancer, the human genomic Cγ1 segment including part of the preceding intron, and a gpt gene. The plasmid pEkappa is similar to pEgamma1 but contains the human genomic CK segment and the hygromycin gene.

For expression of the functionally human antibody, the heavy chain and kappa chain plasmids are transfected into Sp2/0 mouse myeloma cells by electroporation and cells selected for hygromycin expression. Clones secreting a maximal amount of complete antibody are detected by ELISA. Purified antibody is used to test for binding to the antigen of interest (or cells expressing the antigen of interest on their surfaces).

### Example 6

### Construction of a Human V-Region Library for the Light Chain of an Anti-TNF Alpha Antibody Containing Freely Assorted Framework Regions and CDRs from Limited Sequences

For illustration purposes, V-gene assembly of the light chain of the anti-TNF alpha antibody, CA9, was used. The amino acid and nucleotide sequence for the VK region of the anti-TNF alpha antibody CA9 is set forth FIG. 7. Sequence homology search (IgBlast against Kabat system: http://www.ncbi.nlm.nih.gov/igblast/) revealed two human light chain sequences that exhibit high homology (65.4%-66.4%) with the VK sequence of CA9 (FIG. 8). They are: CAG27043 (Immunoglobulin kappa light chain variable region [Homo sapiens]) and ABA26038 (Immunoglobulin light chain variable region [Homo sapiens]).

The FR1, CDR1, FR2, CDR2, FR3, CDR3 and FR4 of these human sequences (FIG. 8?) may be used for the construction of a mini-library containing freely-assorted FR and CDR segments (in the order of FR1-CDR1-FR2-CDR2-FR3-CDR3-FR4 configuration) from the selected sequences (FIG. 8). Theoretically, 3⁶ (729) different combinations can result from these sequences. The recombined sequences are used to pair with the original CA9 VH sequences for the construction of a phage scFv library. Panning is carried out for the identification of scFv phage with specificity against TNF-alpha protein. The light chain V region sequence retrieved from scFv phage that exhibits strong binding to TNF-alpha is then elucidated.

All complementary DNA oligonucleotides encoding the different FR and CDR segments are chemically synthesized (Invitrogen) with the following characteristics:
(1) the antisense strands encoding the FR4 segments are amine-modified at the 5′ termini (for immobilization onto DNA-BIND™ plates);
(2) with the exception of FR3, all sense and anti-sense strand encoding FR and CDR segments are made in one oligosynthetic cycle;
(3) the antisense strands encoding different CDR segments are designed to contain four protruding overhang carrying degenerate nucleotides [(A/T/G/C) (A/T/G/C) (A/T/G/C) (A/T/G/C)] at the 5′ termini and five protruding 3′ overhang with defined sequences at the 3′ termini, respectively;
(4) the sense strands of FR1 and FR2 segments are designed to contain five 3′ protruding overhang carrying degenerate nucleotides [(A/T/G/C) (A/T/G/C) (A/T/G/C) (A/T/G/C) (A/T/G/C)] and four protruding 5′ overhang with defined sequences;
(5) the sense and anti-sense strands encoding FR3 are synthesized in halves; N-FR3 represents the N-terminal half and C-FR3 represents the C-terminal half;
(6) the sense strands of C-FR3 segment are designed to contain five protruding degenerate 3′ overhang [(A/T/G/C) (A/T/G/C) (A/T/G/C) (A/T/G/C) (A/T/G/C)], whereas that of N-FR3 segments contain four protruding 5′ overhang with defined sequences.

Equimolar concentrations of sense and antisense FR4 are mixed and heated at 94° C. for 10 mM. The mixture is allowed to stand at room temperature for annealing. Double-stranded FR4 DNA is diluted in Oligo Binding Buffer (OPB) (50 mM Na₂PO₄, pH 8.5, 1 mM EDTA) and 100 μl of the diluted segment is added to the DNA-BIND™ plate (Costar) at a concentration of 12.5, 25, 50 and 100 μmol/well. The polystyrene surface of the DNA-BIND™ plate is covalently linked with a layer of reactive N-oxysuccinimide esters (NOS groups) which react with nucleophiles such as primary amines (Costar). The coupling with the DNA-BIND™ surface is specific and cannot be washed off from the plate easily. The wells are incubated in a humidified chamber overnight at 4° C., followed by washing with sterile DPBS, pH 7.4 to remove uncoupled oligonucleotides. Unreacted DNA-BIND™ active groups are blocked with 3% Bovine Serum Albumin (BSA) in OPB at room temperature for 2 hours, followed by washing with sterile DPBS, pH 7.4 before ligation.

All antisense FR and CDR oligonucleotides are phosphorylated at the 5′ termini using T4 Polynucleotide kinase (Invitrogen). Phosphorlyation is carried out in 25 μl reaction mixture containing 1× forward reaction buffer (Invitrogen), 1 mM ATP (Invitrogen), 10 units T4 Polynucleotide kinase (Invitrogen) and 2 μM of antisense oligonucleotides. The reaction is incubated at 37° C. for 50 hours or more and then stopped by incubation at 65° C. for 20 min. Equimolar concentrations of sense and corresponding phosphorylated antisense FR (except FR4) and CDR oligonucleotides are mixed and heated at 94° C. for 10 min. The mixture is allowed to stand at room temperature for annealing to form double-stranded CDR3, N-FR3, C-FR3, CDR2, FR2, CDR1 and FR1.

The synthesis of FR3 is made in 25 μl reaction volume containing equimolar concentrations of N-FR3 and C-FR3, 1× T4 ligase reaction buffer (Invitrogen) and 1 unit of T4 DNA ligase (Invitrogen). After overnight incubation at 4° C., the reaction is stopped at 65° C.

Ligation is carried out in 25 μl reaction volume containing 4 μM CDR3 double-stranded DNA, 1× T4 ligase reaction buffer (Invitrogen) and 0.5 unit of T4 DNA ligase (Invitrogen). The mixture is incubated in a humidified chamber at 4° C. for 8 hours or overnight. Un-ligated CDR3 DNAs are washed off with sterile DPBS, pH 7.4. The ligation-wash cycle is repeated with double-stranded FR3, CDR2, FR2, CDR1 and FR1 in a sequential manner by directional sticky end cloning.

A NotI restriction enzyme site is incorporated at the 5′ terminus of antisense FR4 and 3′ terminus of sense FR4. After ligation and washing, restriction enzyme digestion is carried out in 50 μl reaction volume containing 1× NEBuffer 3 (New England BioLabs), 1×BSA (New England BioLabs) and 10 unit NotI (New England BioLabs). The mixture is incubated in a humidified chamber overnight at 37° C. The reaction mixture is transferred to 0.5-ml microcentrifuge tube and the enzyme is inactivated at 65° C. for 20 min.

A universal overhang sequence is incorporated at the upstream position of FR1 segment (DL-R primer: AGCTCGACATCCAGCTGACTCAGTCTCCAG) and at the downstream position of FR4 segment (DL-F primer: TGAGCGGCCGCTTTGATCTCCA). PCR is carried out in 50 μl reaction volume containing 1×PCR buffer (Invitrogen), 1.5 mM MgCl₂ (Invitrogen), 0.2 mM dNTP (Promega, 0.04 U/μl Platinum Taq polymerase (Invitrogen) and 5 μl NotI-digested products. After a 3-min pre-denaturing step, 30 extension cycles are carried out in a Mastercycler® personal PCR thermocycler with a 25-well aluminum plate (Eppendorf). Each cycle consists of denaturation at 94° C. for 45 s, annealing at 60° C. for 45 s, and extension at 72° C. for 45 s, followed by a 10-min post-extension step at 72° C. After PCR, 15 μl of PCR product is analyzed in 1% agarose gel and the results are captured under UV illumination.

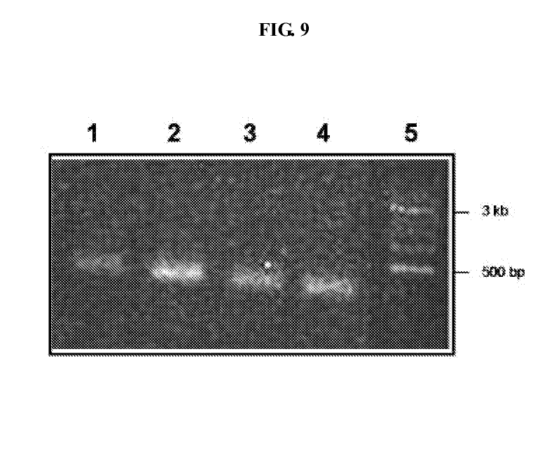

In a trial synthesis, synthetic ligation of a light chain V sequence according to the above procedure was carried out using the sequence alignment as shown in FIG. 9. Briefly, double-stranded FR4 containing an amine group was immobilized on the DNA-BIND™ surface, followed by sequential rounds of ligation with CDR3, FR3 (joined by N-FR3 and C—FR3), CDR2, FR2, CDR1 and FR1. The ligated product was released by NotI digestion, and PCR amplified using the universal flanking primer set (DL-R primer and DL-F primer). FIG. 9 shows the results of gel electrophoresis of the PCR products resulting from the synthesis, suggesting sequential ligation of FR and CDR segments can result in the formation of a full V region sequence.

### Example 7

Identification and Characterization of an alpha-TNF-Specific scFv Phage Containing The VH Sequence of CA9 and the Synthetic Light Chain of an Anti-TNF Alpha Antibody Containing Freely Assorted Framework Regions and CDRs from Limited Sequences

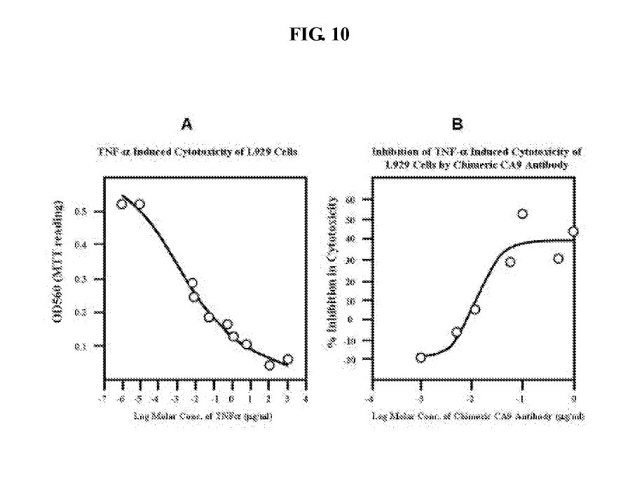

The human VK synthetic sequences as described in Example 6 is used to construct a scFv Phage library containing the VH sequence of CA9. The library undergoes three rounds of panning with different stringency to identify high affinity scFv phage against TNF-alpha antigen, as described in Example 4. TNF-α is known to induce cell cytotoxicity to L929 (murine fibrosarcoma) cells (FIG. 10A). A chimeric version of CA9 is constructed, and demonstrated to neutralize the cell cytotoxicity effect of TNF-α against L929 cells (FIG. 10B). The same assay method may be used to evaluate the ability of the scFv Phage identified for its ability to neutralize TNF-alpha induced cell cytotoxicity.

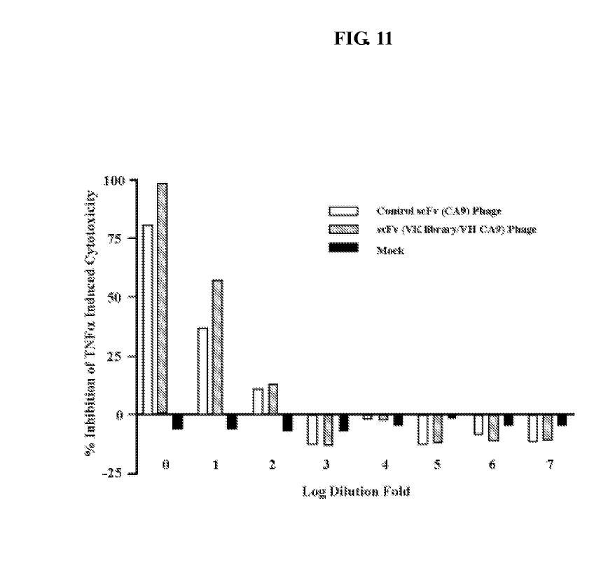

An scFv Phage clone is identified after three rounds of panning against TNF-α antigen at various stringencies. The single scFv Phage is amplified, and its ability to neutralize TNF-alpha induced cell cytotoxicity is evaluated. As shown in FIG. 11, the particular phage is capable of inhibiting TNF-alpha mediated L929 cell cytotoxicity in a dose dependent manner, and the extent of inhibition is greater than that of the control phage which contains the original VK and VH sequence of murine CA9.

### INDUSTRIAL APPLICABILITY

The variety of immunoglobulin sequence databases and corresponding DNA libraries provided herein, containing randomly assembled FR1, CDR1, FR2, CDR2, FR3, CDR3 and FR4 sequences of heavy or light chain immunoglobulin variable regions, find utility in the construction and use of a functionally human antibody library that exhibits a degree of repertoire diversity not found in natural immune systems. The human immunoglobulin phage display library libraries of the present invention can be used to express novel, fully human and non-immunogenic immunoglobulins and to screen for antibodies having a target specificity of interest.

All patents and publications mentioned herein are incorporated by reference in their entirety. Nothing herein is to be construed as an admission that the invention is not entitled to antedate such disclosure by virtue of prior invention.

While the invention has been described in detail and with reference to specific embodiments thereof, it is to be understood that the foregoing description is exemplary and explanatory in nature and is intended to illustrate the invention and its preferred embodiments. Through routine experimentation, one skilled in the art will readily recognize that various changes and modifications can be made therein without departing from the spirit and scope of the invention. Other advantages and features will become apparent from the claims filed hereafter, with the scope of such claims to be determined by their reasonable equivalents, as would be understood by those skilled in the art. Thus, the invention is intended to be defined not by the above description, but by the following claims and their equivalents.

What is claimed is:

1. A method for producing a human immunoglobulin phage display library, the method comprising the steps of:
preparing a first set of nucleotide sequences, the sequences encoding human immunoglobulin light chain variable regions, wherein the sequences of said first set comprise sequences of human light chain cDNA segments encoding FR1, CDR1, FR2, CDR2, FR3, CDR3, and FR4, wherein the segments are randomly selected and ligated to encode a light chain variable region comprising in order FR1-CDR1-FR2-CDR2-FR3-CDR3-FR4;
preparing a second set of nucleotide sequences, the sequences encoding human immunoglobulin heavy chain variable regions, wherein the sequences of said second set comprise sequences of human heavy chain cDNA segments encoding FR1, CDR1, FR2, CDR2, FR3, CDR3, and FR4, wherein the segments are randomly selected and ligated to encode a heavy chain variable region comprising in order FR1-CDR1-FR2-CDR2-FR3-CDR3-FR4;
preparing a third set of nucleotide sequences, the sequences encoding single chain Fv immunoglobulins, wherein the sequences of said third set comprise a light chain sequence from said first set, a linker, and a randomly selected heavy chain sequence from said second set, wherein the linker covalently joins said light chain sequence and said heavy chain sequence such that the sequences of said third set encode single chain Fv immunoglobulins; and
incorporating the third set of nucleotide sequences into a phagemid cloning vector to form a phage display library.

2. The method of claim 1, wherein said human light chain cDNA segments of said first set of nucleotide sequences encode only kappa chains.

3. The method of claim 1, wherein said human light chain cDNA segments of said first set of nucleotide sequences encode only lambda chains.

4. The method of claim 1, wherein said human light chain cDNA segments of said first set of nucleotide sequences encode both kappa and lambda chains.

5. The method of claim 1, wherein said phage display library excludes the associations of FR1-CDR1-FR2-CDR2-FR3.

6. The method of claim 1, wherein said human heavy chain cDNA segments of said second set of nucleotide sequences encode only gamma chains.

7. The method of claim 1, wherein said human heavy chain cDNA segments of said second set of nucleotide sequences encode sequences of γ₁, γ₂, γ₃, γ₄, μ, α₁, α₂, δ, or ε heavy chains.

8. A method of identifying an antigen binding molecule having binding specificity for a target antigen of interest comprising the steps of: (a) panning the human immunoglobulin phage display library of claim 1 for an immunoglobulin that appears to have a binding specificity for said target antigen; (b) expressing said immunoglobulin; and (c) testing the expressed immunoglobulin for binding to said target antigen.

9. A human immunoglobulin phage display library produced by the method of claim 1.


SEQUENCE LISTING (23 sequences)

SEQ ID NO: 1 - DNA, 29 bp, Artificial Sequence
  Description of Artificial Sequence Synthetic primer
cgccgtctagaactatgaacattctgtag

SEQ ID NO: 2 - DNA, 57 bp, Artificial Sequence
  Description of Artificial Sequence Synthetic primer
gcgccgtctagaactaacactctcccctgttgaagctctttgtgacgggcgatctca

SEQ ID NO: 3 - DNA, 30 bp, Artificial Sequence
  Description of Artificial Sequence Synthetic primer
gcatctactagttttgtcacaagatttggg

SEQ ID NO: 4 - DNA, 32 bp, Artificial Sequence
  Description of Artificial Sequence Synthetic primer
gctctagaactaatgcgtgacctggcagctgt

SEQ ID NO: 5 - DNA, 36 bp, Artificial Sequence
  Description of Artificial Sequence Synthetic primer
gctctagaactaatgggtgacttcgcaggcgtagac

SEQ ID NO: 6 - DNA, 31 bp, Artificial Sequence
  Description of Artificial Sequence Synthetic primer
ggactagtgttgcagatgtaggtctgggtgc

SEQ ID NO: 7 - DNA, 19 bp, Artificial Sequence
  Description of Artificial Sequence Synthetic oligonucleotide
gaattcggcccagccggcc

SEQ ID NO: 8 - DNA, 18 bp, Artificial Sequence
  Description of Artificial Sequence Synthetic oligonucleotide
ggcaccacggtcaccgtc

SEQ ID NO: 9 - DNA, 16 bp, Artificial Sequence
  Description of Artificial Sequence Synthetic oligonucleotide
gctcactcagtctcca

SEQ ID NO: 10 - DNA, 18 bp, Artificial Sequence
  Description of Artificial Sequence Synthetic oligonucleotide
gcggccgcaggtgcgccg

SEQ ID NO: 11 - DNA, 19 bp, Artificial Sequence
  Description of Artificial Sequence Synthetic primer
gaattcggcccagccggcc

SEQ ID NO: 12 - DNA, 18 bp, Artificial Sequence
  Description of Artificial Sequence Synthetic primer
gacggtgaccgtggtgcc

SEQ ID NO: 13 - DNA, 16 bp, Artificial Sequence
  Description of Artificial Sequence Synthetic primer
gctcactcagtctcca

SEQ ID NO: 14 - DNA, 18 bp, Artificial Sequence
  Description of Artificial Sequence Synthetic primer
cggcgcacctgcggccgc

SEQ ID NO: 15 - protein, 15 aa, Artificial Sequence
  Description of Artificial Sequence Synthetic peptide
GGGGSGGGGSGGGGS

SEQ ID NO: 16 - DNA, 30 bp, Artificial Sequence
  Description of Artificial Sequence Synthetic primer
agctcgacatccagctgactcagtctccag

SEQ ID NO: 17 - DNA, 22 bp, Artificial Sequence
  Description of Artificial Sequence Synthetic primer
tgagcggccgctttgatctcca

SEQ ID NO: 18 - DNA, 321 bp, Homo sapiens
  CDS (1)..(321)
gacatccagctgactcagtctccagccatcctgtctgtgagtccaggagaaagagtcagtttctcgtgcagggccagtcagttcgttggctcaagcatccactggtatcagcaaagaacaaatggttctccaaggcttctcataaagtatgctagcgagtctatgtctggaattccttccaggtttagtggcagtggatcagggacagattttactcttagcatcaacactgtggagtctgaagatattgcagattattactgtcaacaaagtcatagctggccattcacgttcggctcggggacaaatttggagatcaaa

SEQ ID NO: 19 - protein, 107 aa, Homo sapiens
DIQLTQSPAILSVSPGERVSFSCRASQFVGSSIHWYQQRTNGSPRLLIKYASESMSGIPSRFSGSGSGTDFTLSINTVESEDIADYYCQQSHSWPFTFGSGTNLEIK

SEQ ID NO: 20 - DNA, 321 bp, Homo sapiens
gaaattgtgctgactcagtctccagactttcagtctgtgactccaaaggagaaagtcaccatcacctgccgggccagtcagagcattggtagtagcttacactggtaccagcagaaaccagatcagtctccaaagctcctcatcaagtatgcttcccagtccttctcaggggtcccctcgaggttcagtggcagtggatctgggacagatttcaccctcaccatcaatagcctggaagctgaagatgctgcaacgtattactgtcaacaaagtcatagctggccattcactttcggcggagggaccaaggtggagatcaaa

SEQ ID NO: 21 - DNA, 321 bp, Homo sapiens
gaaattgtgttgacgcagtctccagccaccctgtctgtgtctccaggggaaagagccaccctctcctgcagggccagtcagagtgttagcagcaacttagcctggtaccagcagaaacctggccaggctcccaggctcctcatctatggtgcatccaccagggccactggtatcccagccaggttcagtggcagtgggtctgggacagagttcactctcaccatcagcagcctgcagtctgaagattttgcagtttattactgtcagcagtataataactggccgtacacttttggccaggggaccaagctggagatcaaa

SEQ ID NO: 22 - protein, 107 aa, Homo sapiens
EIVLTQSPDFQSVTPKEKVTITCRASQSIGSSLHWYQQKPDQSPKLLIKYASQSFSGVPSRFSGSGSGTDFTLTINSLEAEDAATYYCQQSHSWPFTFGGGTKVEIK

SEQ ID NO: 23 - protein, 107 aa, Homo sapiens
EIVLTQSPATLSVSPGERATLSCRASQSVSSNLAWYQQKPGQAPRLLIYGASTRATGIPARFSGSGSGTEFTLTISSLQSEDFAVYYCQQYNNWPYTFGQGTKLEIK